(19) United States
(12) Patent Application Publication
(10) Pub. No.: US 2026/0032677 A1
(43) Pub. Date: Jan. 29, 2026

(54) TECHNIQUES FOR SPATIAL RELATION FOR UPLINK CHANNEL

(71) Applicant: QUALCOMM Incorporated, San Diego, CA (US)

(72) Inventors: Qian ZHANG, Basking Ridge, NJ (US); Muhammad Sayed Khairy ABDELGHAFFAR, San Jose, CA (US); Yan ZHOU, San Diego, CA (US)

(21) Appl. No.: 18/787,035

(22) Filed: Jul. 29, 2024

(51) Int. Cl. H04W 72/1268; H04L 5/00; H04L 5/14; H04W 16/28

(52) U.S. Cl. CPC H04W 72/1268; H04L 5/0051; H04L 5/14; H04W 16/28

(57) ABSTRACT

Methods, systems, and devices for wireless communications are described. Techniques described herein provide for the configuration and activation of spatial relations for uplink communications. The spatial relations may be linked to spatial references for one of a physical uplink control channel (PUCCH) resource, a sounding reference signal (SRS) resource, or a physical uplink shared channel (PUSCH) resource. Once activated, a UE may send an uplink communication to a network entity on the indicated PUCCH resource, the SRS resource, or the PUSCH resource in accordance with activated spatial relations. These spatial relations may be activated for sub-band full duplex (SBFD) symbols, non-SBFD symbols, or both.

### FIELD OF TECHNOLOGY

The following relates to wireless communications, including techniques for the configuration and activation of spatial relations for uplink channel communications.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

### SUMMARY

The systems, methods, and devices of this disclosure each have several innovative aspects, no single one of which is solely responsible for the desirable attributes disclosed herein.

A method for wireless communications by a user equipment is described. The method may include receiving first information that configures one or more spatial relations for uplink communications, receiving second information that activates the one or more spatial relations, the one or more spatial relations each associated with a respective spatial reference for one of a physical uplink control channel (PUCCH) resource, a sounding reference signal (SRS) resource, or a physical uplink shared channel (PUSCH) resource, and where the second information activates the one or more spatial relations for sub-band full duplex (SBFD) symbols, non-SBFD symbols, or both, and transmitting the uplink communications via the PUCCH resource, the SRS resource, or the PUSCH resource in accordance with the activated one or more spatial relations for the SBFD symbols, the non-SBFD symbols, or both.

A user equipment for wireless communications is described. The user equipment may include one or more memories storing processor executable code, and one or more processors coupled with the one or more memories. The one or more processors may individually or collectively be operable to execute the code to cause the user equipment to receive first information that configures one or more spatial relations for uplink communications, receive second information that activates the one or more spatial relations, the one or more spatial relations each associated with a respective spatial reference for one of a PUCCH resource, an SRS resource, or an PUSCH resource, and where the second information activates the one or more spatial relations for sub-band full duplex (SBFD) symbols, non-SBFD symbols, or both, and transmit the uplink communications via the PUCCH resource, the SRS resource, or the PUSCH resource in accordance with the activated one or more spatial relations for the SBFD symbols, the non-SBFD symbols, or both.

Another user equipment for wireless communications is described. The user equipment may include means for receiving first information that configures one or more spatial relations for uplink communications, means for receiving second information that activates the one or more spatial relations, the one or more spatial relations each associated with a respective spatial reference for one of a PUCCH resource, an SRS resource, or an PUSCH resource, and where the second information activates the one or more spatial relations for sub-band full duplex (SBFD) symbols, non-SBFD symbols, or both, and means for transmitting the uplink communications via the PUCCH resource, the SRS resource, or the PUSCH resource in accordance with the activated one or more spatial relations for the SBFD symbols, the non-SBFD symbols, or both.

A non-transitory computer-readable medium storing code for wireless communications is described. The code may include instructions executable by one or more processors to receive first information that configures one or more spatial relations for uplink communications, receive second information that activates the one or more spatial relations, the one or more spatial relations each associated with a respective spatial reference for one of a PUCCH resource, an SRS resource, or an PUSCH resource, and where the second information activates the one or more spatial relations for sub-band full duplex (SBFD) symbols, non-SBFD symbols, or both, and transmit the uplink communications via the PUCCH resource, the SRS resource, or the PUSCH resource in accordance with the activated one or more spatial relations for the SBFD symbols, the non-SBFD symbols, or both.

In some examples of the method, user equipment, and non-transitory computer-readable medium described herein, the first information configures, for the PUCCH resource and on a per PUCCH resource basis, a first spatial relation of the one or more spatial relations and the second information includes a first duplex type indicator that activates the first spatial relation for one of the SBFD symbols, the non-SBFD symbols, or both.

In some examples of the method, user equipment, and non-transitory computer-readable medium described herein, the second information includes a second duplex type indicator that indicates whether the PUCCH resource may be restricted to a duplex type indicated by the first duplex type indicator or not.

In some examples of the method, user equipment, and non-transitory computer-readable medium described herein, the first information configures, for the PUCCH resource and on a per PUCCH resource basis, a first spatial relation of the one or more spatial relations and an absence of a first duplex type indicator in the second information indicates that the first spatial relation may be activated for both the SBFD symbols and the non-SBFD symbols.

In some examples of the method, user equipment, and non-transitory computer-readable medium described herein, the first information configures, for the PUCCH resource and on a per PUCCH resource basis, at least one of a first spatial relation of the one or more spatial relations and a second spatial relation of the one or more spatial relations, the first spatial relation may be associated with a first duplex type and the second spatial relation may be associated with a second duplex type, and the first duplex type and the second duplex type may be individually associated with the SBFD symbols, the non-SBFD symbols, or both.

In some examples of the method, user equipment, and non-transitory computer-readable medium described herein, the second information includes both a first duplex type indicator that indicates that the first spatial relation may be associated with the first duplex type and a second duplex type indicator that indicates that the second spatial relation may be associated with the second duplex type.

In some examples of the method, user equipment, and non-transitory computer-readable medium described herein, the second information includes a spatial relation quantity indicator that indicates that only the first spatial relation may be configured and that the first spatial relation may be associated with both the first duplex type and the second duplex type.

In some examples of the method, user equipment, and non-transitory computer-readable medium described herein, the second information includes a spatial relation quantity indicator that indicates that both the first spatial relation and the second spatial relation may be configured and association of the first spatial relation with the first duplex type and of the second spatial relation with the second duplex type may be based on an order of the first spatial relation and the second spatial relation in the second information.

In some examples of the method, user equipment, and non-transitory computer-readable medium described herein, association of the first spatial relation with the first duplex type and of the second spatial relation with the second duplex type may be based on an order of the first spatial relation and the second spatial relation in the second information.

In some examples of the method, user equipment, and non-transitory computer-readable medium described herein, the second information includes a spatial relation quantity indicator that indicates that only the first spatial relation may be configured and the second information further includes a first duplex type indicator that indicates that the first spatial relation may be associated with the first duplex type.

In some examples of the method, user equipment, and non-transitory computer-readable medium described herein, the second information includes a first duplex type indicator that indicates that the first spatial relation may be associated with both the first duplex type and the second duplex type and indication that the first spatial relation may be associated with both the first duplex type and the second duplex type may be indicative that only the first spatial relation may be configured.

In some examples of the method, user equipment, and non-transitory computer-readable medium described herein, the second information includes a first duplex type indicator that indicates that the first spatial relation and the second spatial relation may be associated with different duplex types and the second information includes a second duplex type indicator that indicates that the first spatial relation may be associated with the first duplex type and that the second spatial relation may be associated with the second duplex type.

In some examples of the method, user equipment, and non-transitory computer-readable medium described herein, the first information configures, for the SRS resource and on a per periodic SRS resource basis, a first spatial relation of the one or more spatial relations and a second spatial relation of the one or more spatial relations, the first spatial relation may be associated with a first duplex type and the second spatial relation may be associated with a second duplex type, association of the first spatial relation with the first duplex type and of the second spatial relation with the second duplex type may be based on explicit indication in the first information or on an order of the first spatial relation and the second spatial relation in the first information, and the first duplex type and the second duplex type may be individually associated with the SBFD symbols, the non-SBFD symbols, or both.

In some examples of the method, user equipment, and non-transitory computer-readable medium described herein, the first information configures, for the SRS resource and on a per periodic SRS resource basis, a first spatial relation of the one or more spatial relations, the first spatial relation may be associated with both a first duplex type and a second duplex type or may be associated, based on a duplex indicator restriction, with only one of the first duplex type or the second duplex type, and the first duplex type and the second duplex type may be individually associated with the SBFD symbols, the non-SBFD symbols, or both.

In some examples of the method, user equipment, and non-transitory computer-readable medium described herein, the first information configures, for a first SRS resource and on a per periodic SRS resource basis, a first spatial relation of the one or more spatial relations, and for a second SRS resource, a second spatial relation of the one or more spatial relations, the SRS resource may be one of the first SRS resource or the second SRS resource, and each of the first spatial relation and the second spatial relation may be associated with a respective duplex type indicator that indicates an association with the SBFD symbols, the non-SBFD symbols, or both.

In some examples of the method, user equipment, and non-transitory computer-readable medium described herein, the first information configures, for the SRS resource and on a per semi-persistent SRS resource basis, a first spatial relation of the one or more spatial relations and the second information includes a first duplex type indicator that activates the first spatial relation for one of the SBFD symbols, the non-SBFD symbols, or both.

In some examples of the method, user equipment, and non-transitory computer-readable medium described herein, the second information includes a second duplex type indicator that indicates whether the SRS resource may be restricted to a duplex type indicated by the first duplex type indicator or not.

In some examples of the method, user equipment, and non-transitory computer-readable medium described herein, the first information configures, for the SRS resource and on a per semi-persistent SRS resource basis, a first spatial relation of the one or more spatial relations and an absence of a first duplex type indicator in the second information indicates that the first spatial relation may be activated for both the SBFD symbols and the non-SBFD symbols.

In some examples of the method, user equipment, and non-transitory computer-readable medium described herein, the first information configures, for the SRS resource and on a per semi-persistent SRS resource basis, at least one of a first spatial relation of the one or more spatial relations and a second spatial relation of the one or more spatial relations, the first spatial relation may be associated with a first duplex type and the second spatial relation may be associated with a second duplex type, and the first duplex type and the second duplex type may be individually associated with the SBFD symbols, the non-SBFD symbols, or both.

In some examples of the method, user equipment, and non-transitory computer-readable medium described herein, the second information includes both a first duplex type indicator that indicates that the first spatial relation may be associated with the first duplex type and a second duplex type indicator that indicates that the second spatial relation may be associated with the second duplex type.

In some examples of the method, user equipment, and non-transitory computer-readable medium described herein, the second information includes a spatial relation quantity indicator that indicates that only the first spatial relation may be configured and that the first spatial relation may be associated with both the first duplex type and the second duplex type.

In some examples of the method, user equipment, and non-transitory computer-readable medium described herein, the second information includes a spatial relation quantity indicator that indicates that both the first spatial relation and the second spatial relation may be configured and association of the first spatial relation with the first duplex type and of the second spatial relation with the second duplex type may be based on an order of the first spatial relation and the second spatial relation in the second information.

In some examples of the method, user equipment, and non-transitory computer-readable medium described herein, association of the first spatial relation with the first duplex type and of the second spatial relation with the second duplex type may be based on an order of the first spatial relation and the second spatial relation in the second information.

In some examples of the method, user equipment, and non-transitory computer-readable medium described herein, the second information includes a spatial relation quantity indicator that indicates that only the first spatial relation may be configured and the second information further includes a first duplex type indicator that indicates that the first spatial relation may be associated with the first duplex type.

In some examples of the method, user equipment, and non-transitory computer-readable medium described herein, the second information includes a first duplex type indicator that indicates that the first spatial relation may be associated with both the first duplex type and the second duplex type and indication that the first spatial relation may be associated with both the first duplex type and the second duplex type may be indicative that only the first spatial relation may be configured.

In some examples of the method, user equipment, and non-transitory computer-readable medium described herein, the second information includes a first duplex type indicator that indicates that the first spatial relation and the second spatial relation may be associated with different duplex types and the second information includes a second duplex type indicator that indicates that the first spatial relation may be associated with the first duplex type and that the second spatial relation may be associated with the second duplex type.

In some examples of the method, user equipment, and non-transitory computer-readable medium described herein, the first information configures and the method, apparatuses, and non-transitory computer-readable medium may include further operations, features, means, or instructions for selecting one of the first spatial relation or the second spatial relation for application with the aperiodically triggered SRS resource, where the selection may be based on a target slot type of the aperiodically triggered SRS resource.

In some examples of the method, user equipment, and non-transitory computer-readable medium described herein, the first information configures and the method, apparatuses, and non-transitory computer-readable medium may include further operations, features, means, or instructions for selecting one of the first spatial relation or the second spatial relation for application with the aperiodically triggered SRS resource, where the selection may be based on a duplex type indicator field included in the second information.

In some examples of the method, user equipment, and non-transitory computer-readable medium described herein, the first information configures and the method, apparatuses, and non-transitory computer-readable medium may include further operations, features, means, or instructions for selecting one of the first spatial relation or the second spatial relation for application with the aperiodically triggered SRS resource, where the selection may be based on a symbol type associated with the aperiodically triggered SRS resource.

In some examples of the method, user equipment, and non-transitory computer-readable medium described herein, the second information includes a downlink control information which indicates, for the PUSCH resource, a first SRS resource indicator (SRI) that includes at least a first spatial relation of the one or more spatial relations, the first spatial relation may be associated with a first duplex type via a duplex type indicator, the PUSCH resource may be a Type 2 configured grant or a dynamic grant PUSCH resource and, and the first duplex type may be individually associated with the SBFD symbols, the non-SBFD symbols, or both.

In some examples of the method, user equipment, and non-transitory computer-readable medium described herein, the second information includes a downlink control information which indicates, for the PUSCH resource, a first SRS resource indicator (SRI) that includes a first spatial relation of the one or more spatial relations, the first spatial relation may be associated with either a first duplex type or both the first duplex type and a second duplex type, the PUSCH resource may be a Type 2 configured grant or a dynamic grant PUSCH resource and, and the first duplex type and the second duplex type may be individually associated with the SBFD symbols, the non-SBFD symbols, or both.

In some examples of the method, user equipment, and non-transitory computer-readable medium described herein, the second information includes a downlink control information which indicates, for the PUSCH resource, a first SRS resource indicator (SRI) that includes a first spatial relation of the one or more spatial relations and a second SRI that includes a second spatial relation of the one or more spatial relations, the first spatial relation may be associated with a first duplex type and the second spatial relation may be associated with a second duplex type, the PUSCH resource may be a Type 2 configured grant or a dynamic grant PUSCH resource, and the first duplex type and the second duplex type may be individually associated with the SBFD symbols, the non-SBFD symbols, or both.

In some examples of the method, user equipment, and non-transitory computer-readable medium described herein, the first information configures, for the PUSCH resource and on a per PUSCH resource basis, at least one of a first SRS resource indicator (SRI) and a second SRI, each of the first SRI and the second SRI indicating the one or more spatial relations associated with a duplex type of the SRS resource and the PUSCH resource may be a Type 1 configured grant.

In some examples of the method, user equipment, and non-transitory computer-readable medium described herein, the first information configures an SRS resource indicator for the PUSCH resource on a per PUSCH resource basis, the SRI indicates that the SRS resource may be configured with a first spatial relation of the one or more spatial relations and a second SRI that includes a second spatial relation of the one or more spatial relations for both the SBFD symbols and the non-SBFD symbols, and the PUSCH resource may be a Type 1 configured grant.

In some examples of the method, user equipment, and non-transitory computer-readable medium described herein, the first information configures an SRS resource indicator for the PUSCH resource on a per PUSCH resource basis and the SRI indicates that the SRS resource may be configured with a first spatial relation of the one or more spatial relations associated with a duplex type based on a duplex indicator restriction.

In some examples of the method, user equipment, and non-transitory computer-readable medium described herein, the first information configures, for the PUSCH resource and on a per PUSCH resource basis, a first spatial relation of the one or more spatial relations and a second spatial relation of the one or more spatial relations, the second information activates the first spatial relation for the PUSCH resource, the first spatial relation may be associated with a first duplex type via a duplex type indicator, the first duplex type being individually associated with the SBFD symbols, the non-SBFD symbols, or both, and the PUSCH resource may be a Type 1 configured grant.

In some examples of the method, user equipment, and non-transitory computer-readable medium described herein, the first information configures, for the PUSCH resource and on a per PUSCH resource basis, a first spatial relation of the one or more spatial relations and a second spatial relation of the one or more spatial relations, the second information activates the first spatial relation and the second spatial relation for the PUSCH resource, the first spatial relation may be associated with a first duplex type and the second spatial relation may be associated with a second duplex type, the first duplex type and the second duplex type may be individually associated with the SBFD symbols, the non-SBFD symbols, or both, and the PUSCH resource may be a Type 1 configured grant.

In some examples of the method, user equipment, and non-transitory computer-readable medium described herein, the first information includes a radio resource control message and the second information includes a medium access control control element or a downlink control information.

A method for wireless communications by a network entity is described. The method may include transmitting first information that configures one or more spatial relations for a PUCCH, an SRS, or an PUSCH resource, transmitting second information that activates the one or two respective spatial relations for sub-band full duplex (SBFD) symbols, non-SBFD symbols, or both, and receiving an uplink communication that uses the PUCCH, SRS, or PUSCH resource in accordance with the activated one or two spatial relations for the SBFD symbols, the non-SBFD symbols, or both.

A network entity for wireless communications is described. The network entity may include one or more memories storing processor executable code, and one or more processors coupled with the one or more memories. The one or more processors may individually or collectively be operable to execute the code to cause the network entity to transmit first information that configures one or more spatial relations for a PUCCH, an SRS, or an PUSCH resource, transmit second information that activates the one or two respective spatial relations for sub-band full duplex (SBFD) symbols, non-SBFD symbols, or both, and receive an uplink communication that uses the PUCCH, SRS, or PUSCH resource in accordance with the activated one or two spatial relations for the SBFD symbols, the non-SBFD symbols, or both.

Another network entity for wireless communications is described. The network entity may include means for transmitting first information that configures one or more spatial relations for a PUCCH, an SRS, or an PUSCH resource, means for transmitting second information that activates the one or two respective spatial relations for sub-band full duplex (SBFD) symbols, non-SBFD symbols, or both, and means for receiving an uplink communication that uses the PUCCH, SRS, or PUSCH resource in accordance with the activated one or two spatial relations for the SBFD symbols, the non-SBFD symbols, or both.

A non-transitory computer-readable medium storing code for wireless communications is described. The code may include instructions executable by one or more processors to transmit first information that configures one or more spatial relations for a PUCCH, an SRS, or an PUSCH resource, transmit second information that activates the one or two respective spatial relations for sub-band full duplex (SBFD) symbols, non-SBFD symbols, or both, and receive an uplink communication that uses the PUCCH, SRS, or PUSCH resource in accordance with the activated one or two spatial relations for the SBFD symbols, the non-SBFD symbols, or both.

In some examples of the method, network entities, and non-transitory computer-readable medium described herein, the first information configures, for the PUCCH resource and on a per PUCCH resource basis, a first spatial relation of the one or more spatial relations and the second information includes a first duplex type indicator that activates the first spatial relation for one of the SBFD symbols, the non-SBFD symbols, or both.

In some examples of the method, network entities, and non-transitory computer-readable medium described herein, the information includes a second duplex type indicator that indicates whether the PUCCH resource may be restricted to a duplex type indicated by the first duplex type indicator or not.

In some examples of the method, network entities, and non-transitory computer-readable medium described herein, the first information configures, for the PUCCH resource and on a per PUCCH resource basis, a first spatial relation of the one or more spatial relations and an absence of a first duplex type indicator in the second information indicates that the first spatial relation may be activated for both the SBFD symbols and the non-SBFD symbols.

In some examples of the method, network entities, and non-transitory computer-readable medium described herein, the first information configures, for the PUCCH resource and on a per PUCCH resource basis, at least one of a first spatial relation of the one or more spatial relations and a second spatial relation of the one or more spatial relations, the first spatial relation may be associated with a first duplex type and the second spatial relation may be associated with a second duplex type, and the first duplex type and the second duplex type may be individually associated with the SBFD symbols, the non-SBFD symbols, or both.

In some examples of the method, network entities, and non-transitory computer-readable medium described herein, the second information includes both a first duplex type indicator that indicates that the first spatial relation may be associated with the first duplex type and a second duplex type indicator that indicates that the second spatial relation may be associated with the second duplex type.

In some examples of the method, network entities, and non-transitory computer-readable medium described herein, the second information includes a spatial relation quantity indicator that indicates that only the first spatial relation may be configured and that the first spatial relation may be associated with both the first duplex type and the second duplex type.

In some examples of the method, network entities, and non-transitory computer-readable medium described herein, the second information includes a spatial relation quantity indicator that indicates that both the first spatial relation and the second spatial relation may be configured and association of the first spatial relation with the first duplex type and of the second spatial relation with the second duplex type may be based on an order of the first spatial relation and the second spatial relation in the second information.

In some examples of the method, network entities, and non-transitory computer-readable medium described herein, association of the first spatial relation with the first duplex type and of the second spatial relation with the second duplex type may be based on an order of the first spatial relation and the second spatial relation in the second information.

In some examples of the method, network entities, and non-transitory computer-readable medium described herein, the second information includes a spatial relation quantity indicator that indicates that only the first spatial relation may be configured and the second information further includes a first duplex type indicator that indicates that the first spatial relation may be associated with the first duplex type.

In some examples of the method, network entities, and non-transitory computer-readable medium described herein, the second information includes a first duplex type indicator that indicates that the first spatial relation may be associated with both the first duplex type and the second duplex type and indication that the first spatial relation may be associated with both the first duplex type and the second duplex type may be indicative that only the first spatial relation may be configured.

In some examples of the method, network entities, and non-transitory computer-readable medium described herein, the second information includes a first duplex type indicator that indicates that the first spatial relation and the second spatial relation may be associated with different duplex types and the second information includes a second duplex type indicator that indicates that the first spatial relation may be associated with the first duplex type and that the second spatial relation may be associated with the second duplex type.

In some examples of the method, network entities, and non-transitory computer-readable medium described herein, the first information configures, for the SRS resource and on a per periodic SRS resource basis, a first spatial relation of the one or more spatial relations and a second spatial relation of the one or more spatial relations, the first spatial relation may be associated with a first duplex type and the second spatial relation may be associated with a second duplex type, association of the first spatial relation with the first duplex type and of the second spatial relation with the second duplex type may be based on explicit indication in the first information or on an order of the first spatial relation and the second spatial relation in the first information, and the first duplex type and the second duplex type may be individually associated with the SBFD symbols, the non-SBFD symbols, or both.

In some examples of the method, network entities, and non-transitory computer-readable medium described herein, the first information configures, for the SRS resource and on a per periodic SRS resource basis, a first spatial relation of the one or more spatial relations, the first spatial relation may be associated with both a first duplex type and a second duplex type or may be associated, based on a duplex indicator restriction, with only one of the first duplex type or the second duplex type, and the first duplex type and the second duplex type may be individually associated with the SBFD symbols, the non-SBFD symbols, or both.

In some examples of the method, network entities, and non-transitory computer-readable medium described herein, the first information configures, for a first SRS resource and on a per periodic SRS resource basis, a first spatial relation of the one or more spatial relations, and for a second SRS resource, a second spatial relation of the one or more spatial relations, the SRS resource may be one of the first SRS resource or the second SRS resource, and each of the first spatial relation and the second spatial relation may be associated with a respective duplex type indicator that indicates an association with the SBFD symbols, the non-SBFD symbols, or both.

In some examples of the method, network entities, and non-transitory computer-readable medium described herein, the first information configures, for the SRS resource and on a per semi-persistent SRS resource basis, a first spatial relation of the one or more spatial relations and the second information includes a first duplex type indicator that activates the first spatial relation for one of the SBFD symbols, the non-SBFD symbols, or both.

In some examples of the method, network entities, and non-transitory computer-readable medium described herein, the second information includes a second duplex type indicator that indicates whether the SRS resource may be restricted to a duplex type indicated by the first duplex type indicator or not.

In some examples of the method, network entities, and non-transitory computer-readable medium described herein, the first information configures, for the SRS resource and on a per semi-persistent SRS resource basis, a first spatial relation of the one or more spatial relations and an absence of a first duplex type indicator in the second information indicates that the first spatial relation may be activated for both the SBFD symbols and the non-SBFD symbols.

In some examples of the method, network entities, and non-transitory computer-readable medium described herein, the first information configures, for the SRS resource and on a per semi-persistent SRS resource basis, at least one of a first spatial relation of the one or more spatial relations and a second spatial relation of the one or more spatial relations, the first spatial relation may be associated with a first duplex type and the second spatial relation may be associated with a second duplex type, and the first duplex type and the second duplex type may be individually associated with the SBFD symbols, the non-SBFD symbols, or both.

In some examples of the method, network entities, and non-transitory computer-readable medium described herein, the second information includes both a first duplex type indicator that indicates that the first spatial relation may be associated with the first duplex type and a second duplex type indicator that indicates that the second spatial relation may be associated with the second duplex type.

In some examples of the method, network entities, and non-transitory computer-readable medium described herein, the second information includes a spatial relation quantity indicator that indicates that only the first spatial relation may be configured and that the first spatial relation may be associated with both the first duplex type and the second duplex type.

In some examples of the method, network entities, and non-transitory computer-readable medium described herein, the second information includes a spatial relation quantity indicator that indicates that both the first spatial relation and the second spatial relation may be configured and association of the first spatial relation with the first duplex type and of the second spatial relation with the second duplex type may be based on an order of the first spatial relation and the second spatial relation in the second information.

In some examples of the method, network entities, and non-transitory computer-readable medium described herein, association of the first spatial relation with the first duplex type and of the second spatial relation with the second duplex type may be based on an order of the first spatial relation and the second spatial relation in the second information.

In some examples of the method, network entities, and non-transitory computer-readable medium described herein, the second information includes a spatial relation quantity indicator that indicates that only the first spatial relation may be configured and the second information further includes a first duplex type indicator that indicates that the first spatial relation may be associated with the first duplex type.

In some examples of the method, network entities, and non-transitory computer-readable medium described herein, the second information includes a first duplex type indicator that indicates that the first spatial relation may be associated with both the first duplex type and the second duplex type and indication that the first spatial relation may be associated with both the first duplex type and the second duplex type may be indicative that only the first spatial relation may be configured.

In some examples of the method, network entities, and non-transitory computer-readable medium described herein, the second information includes a first duplex type indicator that indicates that the first spatial relation and the second spatial relation may be associated with different duplex types and the second information includes a second duplex type indicator that indicates that the first spatial relation may be associated with the first duplex type and that the second spatial relation may be associated with the second duplex type.

In some examples of the method, network entities, and non-transitory computer-readable medium described herein, the first information configures, for the SRS resource, at least one of a first spatial relation of the one or more spatial relations and a second spatial relation of the one or more spatial relations, the SRS resource may be an aperiodically triggered SRS resource, each of the first spatial relation and the second spatial relation may be associated with a respective duplex type that indicates an association with the SBFD symbols, the non-SBFD symbols, or both, and the uplink communication may be received in accordance with the first spatial relation or the second spatial relation based on a target slot type of the aperiodically triggered SRS resource.

In some examples of the method, network entities, and non-transitory computer-readable medium described herein, the first information configures, for the SRS resource, a first spatial relation of the one or more spatial relations and a second spatial relation of the one or more spatial relations, the SRS resource may be an aperiodically triggered SRS resource, each of the first spatial relation and the second spatial relation may be associated with a respective duplex type that indicates an association with the SBFD symbols, the non-SBFD symbols, or both, and the uplink communication may be received in accordance with the first spatial relation or the second spatial relation based on a duplex type indicator field included in the second information.

In some examples of the method, network entities, and non-transitory computer-readable medium described herein, the first information configures, for the SRS resource, a first spatial relation of the one or more spatial relations and a second spatial relation of the one or more spatial relations, the SRS resource may be an aperiodically triggered SRS resource, each of the first spatial relation and the second spatial relation may be associated with a respective duplex type that indicates an association with the SBFD symbols, the non-SBFD symbols, or both, and the uplink communication may be received in accordance with the first spatial relation or the second spatial relation based on a symbol type associated with the aperiodically triggered SRS resource.

In some examples of the method, network entities, and non-transitory computer-readable medium described herein, the second information includes a downlink control information which indicates, for the PUSCH resource, a first SRS resource indicator (SRI) that includes at least a first spatial relation of the one or more spatial relations, the first spatial relation may be associated with a first duplex type via a duplex type indicator, the PUSCH resource may be a Type 2 configured grant or a dynamic grant PUSCH resource and, and the first duplex type may be individually associated with the SBFD symbols, the non-SBFD symbols, or both.

In some examples of the method, network entities, and non-transitory computer-readable medium described herein, the second information includes a downlink control information which indicates, for the PUSCH resource, a first SRS resource indicator (SRI) that includes a first spatial relation of the one or more spatial relations, the first spatial relation may be associated with either a first duplex type or both the first duplex type and a second duplex type, the PUSCH resource may be a Type 2 configured grant or a dynamic grant PUSCH resource and, and the first duplex type and the second duplex type may be individually associated with the SBFD symbols, the non-SBFD symbols, or both.

In some examples of the method, network entities, and non-transitory computer-readable medium described herein, the second information includes a downlink control information which indicates, for the PUSCH resource, a first SRS resource indicator (SRI) that includes a first spatial relation of the one or more spatial relations and a second SRI that includes a second spatial relation of the one or more spatial relations, the first spatial relation may be associated with a first duplex type and the second spatial relation may be associated with a second duplex type, the PUSCH resource may be a Type 2 configured grant or a dynamic grant PUSCH resource and, and the first duplex type and the second duplex type may be individually associated with the SBFD symbols, the non-SBFD symbols, or both.

In some examples of the method, network entities, and non-transitory computer-readable medium described herein, the first information configures, for the PUSCH resource and on a per PUSCH resource basis, at least one of a first SRS resource indicator (SRI) and a second SRI, each of the first SRI and the second SRI indicating the one or more spatial relations associated with a duplex type of the SRS resource and the PUSCH resource may be a Type 1 configured grant.

In some examples of the method, network entities, and non-transitory computer-readable medium described herein, the first information configures an SRS resource indicator for the PUSCH resource on a per PUSCH resource basis, the SRI indicates that the SRS resource may be configured with a first spatial relation of the one or more spatial relations and a second SRI that includes a second spatial relation of the one or more spatial relations for both the SBFD symbols and the non-SBFD symbols, and the PUSCH resource may be a Type 1 configured grant.

In some examples of the method, network entities, and non-transitory computer-readable medium described herein, the first information configures an SRS resource indicator for the PUSCH resource on a per PUSCH resource basis and the SRI indicates that the SRS resource may be configured with a first spatial relation of the one or more spatial relations associated with a duplex type based on a duplex indicator restriction.

In some examples of the method, network entities, and non-transitory computer-readable medium described herein, the first information configures, for the PUSCH resource and on a per PUSCH resource basis, a first spatial relation of the one or more spatial relations and a second spatial relation of the one or more spatial relations, the second information activates the first spatial relation for the PUSCH resource, the first spatial relation may be associated with a first duplex type via a duplex type indicator, the first duplex type being individually associated with the SBFD symbols, the non-SBFD symbols, or both, and the PUSCH resource may be a Type 1 configured grant.

In some examples of the method, network entities, and non-transitory computer-readable medium described herein, the first information configures, for the PUSCH resource and on a per PUSCH resource basis, a first spatial relation of the one or more spatial relations and a second spatial relation of the one or more spatial relations, the second information activates the first spatial relation and the second spatial relation for the PUSCH resource, the first spatial relation may be associated with a first duplex type and the second spatial relation may be associated with a second duplex type, the first duplex type and the second duplex type may be individually associated with the SBFD symbols, the non-SBFD symbols, or both, and the PUSCH resource may be a Type 1 configured grant.

In some examples of the method, network entities, and non-transitory computer-readable medium described herein, the first information includes a radio resource control message and the second information includes a medium access control control element or a downlink control information.

Details of one or more implementations of the subject matter described in this disclosure are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

FIG. 1 shows an example of a wireless communications system that supports techniques for the configuration and activation of spatial relations for uplink channel communications in accordance with one or more aspects of the present disclosure.

FIG. 2 shows an example of a wireless communications system that supports techniques for the configuration and activation of spatial relations for uplink channel communications in accordance with one or more aspects of the present disclosure.

FIG. 3 shows an example of a medium access control control element (MAC-CE) diagram that supports techniques for the configuration and activation of spatial relations for uplink channel communications in accordance with one or more aspects of the present disclosure.

FIG. 4 shows an example of a MAC-CE diagram that supports techniques for the configuration and activation of spatial relations for uplink channel communications in accordance with one or more aspects of the present disclosure.

FIG. 5 shows an example of a MAC-CE diagram that supports techniques for the configuration and activation of spatial relations for uplink channel communications in accordance with one or more aspects of the present disclosure.

FIG. 6 shows an example of a MAC-CE diagram that supports techniques for the configuration and activation of spatial relations for uplink channel communications in accordance with one or more aspects of the present disclosure.

FIG. 7 shows an example of a process flow diagram that supports techniques for the configuration and activation of spatial relations for uplink channel communications in accordance with one or more aspects of the present disclosure.

FIGS. 8 and 9 show block diagrams of devices that support techniques for the configuration and activation of spatial relations for uplink channel communications in accordance with one or more aspects of the present disclosure.

FIG. 10 shows a block diagram of a communications manager that supports techniques for the configuration and activation of spatial relations for uplink channel communications in accordance with one or more aspects of the present disclosure.

FIG. 11 shows a diagram of a system including a device that supports techniques for the configuration and activation of spatial relations for uplink channel communications in accordance with one or more aspects of the present disclosure.

FIGS. 12 and 13 show block diagrams of devices that support techniques for the configuration and activation of spatial relations for uplink channel communications in accordance with one or more aspects of the present disclosure.

FIG. 14 shows a block diagram of a communications manager that supports techniques for the configuration and activation of spatial relations for uplink channel communications in accordance with one or more aspects of the present disclosure.

FIG. 15 shows a diagram of a system including a device that supports techniques for the configuration and activation of spatial relations for uplink channel communications in accordance with one or more aspects of the present disclosure.

FIGS. 16 and 17 show flowcharts illustrating methods that support techniques for the configuration and activation of spatial relations for uplink channel communications in accordance with one or more aspects of the present disclosure.

### DETAILED DESCRIPTION

In some examples, a wireless communications system may support one or more duplex modes (e.g., half duplex, full duplex, subband full duplex, among other examples). Devices operating in a full duplex mode may generate or experience cross-link interference (CLI). Such CLI may include CLI between user equipments (UEs) (e.g., intra-cell CLI, inter-cell CLI), and interference between network entities (inter-network entity CLI). In some examples, wireless devices may perform CLI measurements to detect and mitigate CLI (e.g., one network entity may perform CLI measurements to detect inter network entity CLI from another network entity). However, if other devices are transmitting during such CLI measurements, then such CLI measurements may fail, or may be inaccurate, resulting in less effective or ineffective CLI mitigation, poor channel performance, failed transmissions, decreased reliability of wireless signaling, increased system latency, and decreased user experience.

Spatial relations involve concepts such as Multiple Input Multiple Output (MIMO), beamforming, and spatial multiplexing. These concepts leverage the spatial aspect of communication channels to improve the efficiency and performance of wireless networks. For example, in beamforming, a wireless device may shape the antenna pattern in 3D space to direct energy towards the target users and to avoid non-target users and obstacles thereby reducing interference for unwanted directions. In another example, various MIMO configurations may include the configuration of the number of antennas, their distribution, and how they are utilized for transmitting and receiving signals which may reduce interference and enhance signal gains.

Techniques described herein provide for the configuration and activation of spatial relations for uplink communications. The spatial relations may be linked to spatial references for one of a physical uplink control channel (PUCCH) resource, a sounding reference signal (SRS) resource, or a physical uplink shared channel (PUSCH) resource. Once activated, a UE may send an uplink communication to a network entity on the indicated PUCCH resource, the SRS resource, or the PUSCH resource in accordance with activated spatial relations. These spatial relations may be activated for sub-band full duplex (SBFD) symbols, non-SBFD symbols, or both.

Aspects of the disclosure are initially described in the context of wireless communications systems. Aspects of the disclosure are further illustrated by and described with reference to spatial relation diagrams and process flows. Aspects of the disclosure are further illustrated by and described with reference to apparatus diagrams, system diagrams, and flowcharts that relate to techniques for the configuration and activation of spatial relations for uplink channel communications.

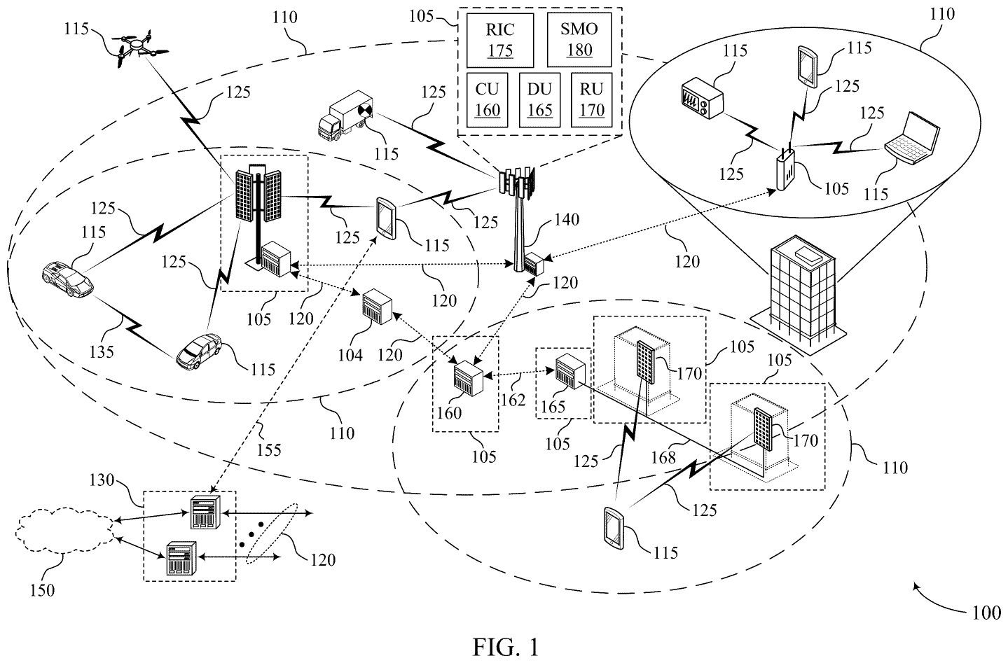

FIG. 1 shows an example of a wireless communications system 100 that supports techniques for the configuration and activation of spatial relations for uplink channel communications in accordance with one or more aspects of the present disclosure. The wireless communications system 100 may include one or more devices, such as one or more network devices (e.g., network entities 105), one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via communication link(s) 125 (e.g., a radio frequency (RF) access link). For example, a network entity 105 may support a coverage area 110 (e.g., a geographic coverage area) over which the UEs 115 and the network entity 105 may establish the communication link(s) 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices in the wireless communications system 100 (e.g., other wireless communication devices, including UEs 115 or network entities 105), as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with a core network 130, or with one another, or both. For example, network entities 105 may communicate with the core network 130 via backhaul communication link(s) 120 (e.g., in accordance with an S1, N2, N3, or other interface protocol). In some examples, network entities 105 may communicate with one another via backhaul communication link(s) 120 (e.g., in accordance with an X2, Xn, or other interface protocol) either directly (e.g., directly between network entities 105) or indirectly (e.g., via the core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication link(s) 120, midhaul communication links 162, or fronthaul communication links 168 may be or include one or more wired links (e.g., an electrical link, an optical fiber link) or one or more wireless links (e.g., a radio link, a wireless optical link), among other examples or various combinations thereof. A UE 115 may communicate with the core network 130 via a communication link 155.

One or more of the network entities 105 or network equipment described herein may include or may be referred to as a base station 140 (e.g., a base transceiver station, a radio base station, an NR base station, an access point, a radio transceiver, a NodeB, an eNodeB (eNB), a next-generation NodeB or giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within one network entity (e.g., a network entity 105 or a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among multiple network entities (e.g., network entities 105), such as an integrated access and backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU), such as a CU 160, a distributed unit (DU), such as a DU 165, a radio unit (RU), such as an RU 170, a RAN Intelligent Controller (RIC), such as an RIC 175 (e.g., a Near-Real Time RIC (Near-RT RIC), a Non-Real Time RIC (Non-RT RIC)), a Service Management and Orchestration (SMO) system, such as an SMO system 180, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more of the network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, or any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaptation protocol (SDAP), Packet Data Convergence Protocol (PDCP)). The CU 160 (e.g., one or more CUs) may be connected to a DU 165 (e.g., one or more DUs) or an RU 170 (e.g., one or more RUs), or some combination thereof, and the DUs 165, RUs 170, or both may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or multiple different RUs, such as an RU 170). In some cases, a functional split between a CU 160 and a DU 165 or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to a DU 165 via a midhaul communication link 162 (e.g., F1, F1-c, F1-u), and a DU 165 may be connected to an RU 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities (e.g., one or more of the network entities 105) that are in communication via such communication links.

In some wireless communications systems (e.g., the wireless communications system 100), infrastructure and spectral resources for radio access may support wireless backhaul link capabilities to supplement wired backhaul connections, providing an IAB network architecture (e.g., to a core network 130). In some cases, in an IAB network, one or more of the network entities 105 (e.g., network entities 105 or IAB node(s) 104) may be partially controlled by each other. The IAB node(s) 104 may be referred to as a donor entity or an IAB donor. A DU 165 or an RU 170 may be partially controlled by a CU 160 associated with a network entity 105 or base station 140 (such as a donor network entity or a donor base station). The one or more donor entities (e.g., IAB donors) may be in communication with one or more additional devices (e.g., IAB node(s) 104) via supported access and backhaul links (e.g., backhaul communication link(s) 120). IAB node(s) 104 may include an IAB mobile termination (IAB-MT) controlled (e.g., scheduled) by one or more DUs (e.g., DUs 165) of a coupled IAB donor. An IAB-MT may be equipped with an independent set of antennas for relay of communications with UEs 115 or may share the same antennas (e.g., of an RU 170) of IAB node(s) 104 used for access via the DU 165 of the IAB node(s) 104 (e.g., referred to as virtual IAB-MT (vIAB-MT)). In some examples, the IAB node(s) 104 may include one or more DUs (e.g., DUs 165) that support communication links with additional entities (e.g., IAB node(s) 104, UEs 115) within the relay chain or configuration of the access network (e.g., downstream). In such cases, one or more components of the disaggregated RAN architecture (e.g., the IAB node(s) 104 or components of the IAB node(s) 104) may be configured to operate according to the techniques described herein.

In the case of the techniques described herein applied in the context of a disaggregated RAN architecture, one or more components of the disaggregated RAN architecture may be configured to support test as described herein. For example, some operations described as being performed by a UE 115 or a network entity 105 (e.g., a base station 140) may additionally, or alternatively, be performed by one or more components of the disaggregated RAN architecture (e.g., components such as an IAB node, a DU 165, a CU 160, an RU 170, an RIC 175, an SMO system 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, vehicles, or meters, among other examples.

The UEs 115 described herein may be able to communicate with various types of devices, such as UEs 115 that may sometimes operate as relays, as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via the communication link(s) 125 (e.g., one or more access links) using resources associated with one or more carriers. The term “carrier” may refer to a set of RF spectrum resources having a defined PHY layer structure for supporting the communication link(s) 125. For example, a carrier used for the communication link(s) 125 may include a portion of an RF spectrum band (e.g., a bandwidth part (BWP)) that is operated according to one or more PHY layer channels for a given RAT (e.g., LTE, LTE-A, LTE-A Pro, NR). Each PHY layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities, such as one or more of the network entities 105).

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems, such as the wireless communications system 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (STTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to UEs 115 (e.g., one or more UEs) or may include UE-specific search space sets for sending control information to a UE 115 (e.g., a specific UE).

In some examples, a network entity 105 (e.g., a base station 140, an RU 170) may be movable and therefore provide communication coverage for a moving coverage area, such as the coverage area 110. In some examples, coverage areas 110 (e.g., different coverage areas) associated with different technologies may overlap, but the coverage areas 110 (e.g., different coverage areas) may be supported by the same network entity (e.g., a network entity 105). In some other examples, overlapping coverage areas, such as a coverage area 110, associated with different technologies may be supported by different network entities (e.g., the network entities 105). The wireless communications system 100 may include, for example, a heterogeneous network in which different types of the network entities 105 support communications for coverage areas 110 (e.g., different coverage areas) using the same or different RATs.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs (e.g., one or more of the UEs 115) via a device-to-device (D2D) communication link, such as a D2D communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to one or more of the UEs 115 in the group. In some examples, a network entity 105 may facilitate the scheduling of resources for D2D communications. In some other examples, D2D communications may be carried out between the UEs 115 without an involvement of a network entity 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than one hundred kilometers) compared to communications using the smaller frequencies and longer waves of the high frequency (HF) or very high frequency (VHF) portion of the spectrum below 300 MHZ.

The wireless communications system 100 may utilize both licensed and unlicensed RF spectrum bands. For example, the wireless communications system 100 may employ License Assisted Access (LAA), LTE-Unlicensed (LTE-U) RAT, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

The network entities 105 or the UEs 115 may use MIMO communications to exploit multipath signal propagation and increase spectral efficiency by transmitting or receiving multiple signals via different spatial layers. Such techniques may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream and may carry information associated with the same data stream (e.g., the same codeword) or different data streams (e.g., different codewords). Different spatial layers may be associated with different antenna ports used for channel measurement and reporting. MIMO techniques include single-user MIMO (SU-MIMO), for which multiple spatial layers are transmitted to the same receiving device, and multiple-user MIMO (MU-MIMO), for which multiple spatial layers are transmitted to multiple devices.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A network entity 105 or a UE 115 may use beam sweeping techniques as part of beamforming operations. For example, a network entity 105 (e.g., a base station 140, an RU 170) may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a network entity 105 multiple times along different directions. For example, the network entity 105 may transmit a signal according to different beamforming weight sets associated with different directions of transmission. Transmissions along different beam directions may be used to identify (e.g., by a transmitting device, such as a network entity 105, or by a receiving device, such as a UE 115) a beam direction for later transmission or reception by the network entity 105.

Some signals, such as data signals associated with a particular receiving device, may be transmitted by a transmitting device (e.g., a network entity 105 or a UE 115) along a single beam direction (e.g., a direction associated with the receiving device, such as another network entity 105 or UE 115). In some examples, the beam direction associated with transmissions along a single beam direction may be determined based on a signal that was transmitted along one or more beam directions. For example, a UE 115 may receive one or more of the signals transmitted by the network entity 105 along different directions and may report to the network entity 105 an indication of the signal that the UE 115 received with a highest signal quality or an otherwise acceptable signal quality.

In some examples, transmissions by a device (e.g., by a network entity 105 or a UE 115) may be performed using multiple beam directions, and the device may use a combination of digital precoding or beamforming to generate a combined beam for transmission (e.g., from a network entity 105 to a UE 115). The UE 115 may report feedback that indicates precoding weights for one or more beam directions, and the feedback may correspond to a configured set of beams across a system bandwidth or one or more sub-bands. The network entity 105 may transmit a reference signal (e.g., a cell-specific reference signal (CRS), a channel state information reference signal (CSI-RS)), which may be precoded or unprecoded. The UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted along one or more directions by a network entity 105 (e.g., a base station 140, an RU 170), a UE 115 may employ similar techniques for transmitting signals multiple times along different directions (e.g., for identifying a beam direction for subsequent transmission or reception by the UE 115) or for transmitting a signal along a single direction (e.g., for transmitting data to a receiving device).

A receiving device (e.g., a UE 115) may perform reception operations in accordance with multiple receive configurations (e.g., directional listening) when receiving various signals from a transmitting device (e.g., a network entity 105), such as synchronization signals, reference signals, beam selection signals, or other control signals. For example, a receiving device may perform reception in accordance with multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned along a beam direction determined based on listening according to different receive configuration directions (e.g., a beam direction determined to have a highest signal strength, highest signal-to-noise ratio (SNR), or otherwise acceptable signal quality based on listening according to multiple beam directions).

Techniques described herein provide for the configuration and activation of spatial relations for uplink communications. The spatial relations may be linked to spatial references for one of a physical uplink control channel (PUCCH) resource, a sounding reference signal (SRS) resource, or a physical uplink shared channel (PUSCH) resource. Once activated, a UE may send an uplink communication to a network entity on the indicated PUCCH resource, the SRS resource, or the PUSCH resource in accordance with activated spatial relations. These spatial relations may be activated for sub-band full duplex (SBFD) symbols, non-SBFD symbols, or both.

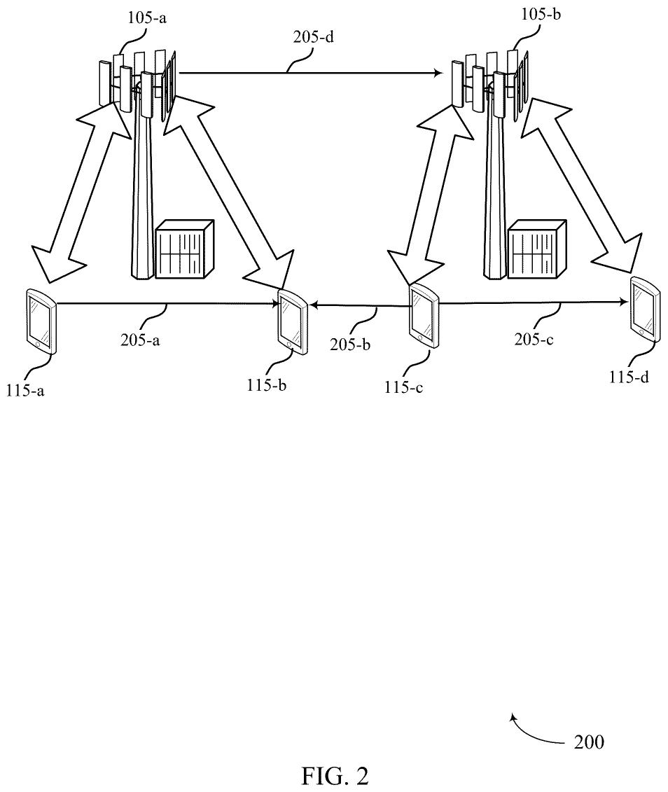

FIG. 2 shows an example of a wireless communications system 200 that supports techniques for the configuration and activation of spatial relations for uplink channel communications in accordance with various aspects of the present disclosure. Wireless communications system 200 may implement, or be implemented by, aspects of wireless communications system 100. For example, wireless communications system 200 may include one or more network entities 105 (e.g., network entity 105-a and network entity 105-b), and one or more UEs 115 (e.g., UE 115-a, UE 115-b, UE 115-c, and UE 115-d), which may be examples of corresponding devices described with reference to FIG. 1. Each network entity 105 may serve one or more UEs (e.g., network entity 105-a may serve UE 115-a and UE 115-b, which may be located in a cell or coverage area corresponding to network entity 105-a, and network entity 105-b may serve UE 115-c and UE 115-d, which may be located in a cell or coverage area corresponding to network entity 105-b).

One or more devices in wireless communications system 200 may support full duplex operations (e.g., SBFD operations in a time domain carrier or intra-band carrier aggregation scenario). For example, network entity 105-b may support SBFD operations, and may perform simultaneous transmission and reception of uplink signaling (e.g., from UE 115-c) and downlink signaling (e.g., to UE 115-d). Uplink and downlink signaling may be scheduled to include downlink resources (e.g., one or more downlink subbands and one or more uplink subbands within the same slot, which may be separated by one or more guard bands). Such SBFD deployments may support increased uplink duty cycles, leading to latency reduction and uplink coverage improvements. SBFD deployments may also enhance system capacity, resource utilization, and spectrum efficiency, and may enable flexible and dynamic uplink and downlink resource adaptations according to uplink and downlink traffic in a robust manner. Some SBFD deployments may support SBFD operations at a UE 115. For example, UE 115-a may simultaneously transmit uplink signaling to network entity 105-a and receive downlink signaling from network entity 105-a.

One or more devices operation in a full duplex mode (e.g., a SBFD mode) may generate or experience cross-link interference (CLI). Such CLI may include inter-subband CLI, inter-cell CLI, inter-UE CLI, intra-cell CLI, and inter-gNB CLI (e.g., in-band inter-gNB CLI). CLI 205 (e.g., inter-cell, intra-cell, inter-UE, inter-gNB, etc.) may or may not be inter-subband CLI. For example, the wireless communications system 200 may support fully overlapping full duplex communications (e.g., in which case multiple UEs 115 are performing full duplex communications via the same subbands (e.g., the same uplink subband and the same downlink subbands)). For example, UE 115-a may transmit uplink signaling, while UE 115-b is monitoring for downlink signaling. The uplink signaling transmitted by UE 115-a may result in intra-cell CLI 205-a (e.g., inter-UE, inter-subband CLI), which may impact UE 115-b when attempting to receive downlink signaling from network entity 105-a. Similarly, UE 115-c may transmit uplink signaling to network entity 105-b, which may result in inter-cell interference 205-b (e.g., inter-subband inter-cell inter-UE CLI) for UE 115-b, and intra-cell interference 205-c (e.g., inter-SB intra-cell interference) for UE 115-d.

To mitigate or avoid such CLI 205, wireless communications devices may adapt spatial relation configurations in order to reduce interference and enhance signal gains. For example, a UE 115 may receive a configuration of spatial relations for uplink communications. The spatial relations may be linked to spatial references for one of a PUCCH resource, an SRS resource, or a PUSCH resource. Once activated by a signal such as a medium access control control element (MAC-CE) or a downlink control information (DCI), a UE may send an uplink communication to a network entity on the indicated PUCCH resource, the SRS resource, or the PUSCH resource in accordance with activated spatial relations. These spatial relations may be activated for sub-band full duplex (SBFD) symbols, non-SBFD symbols, or both.

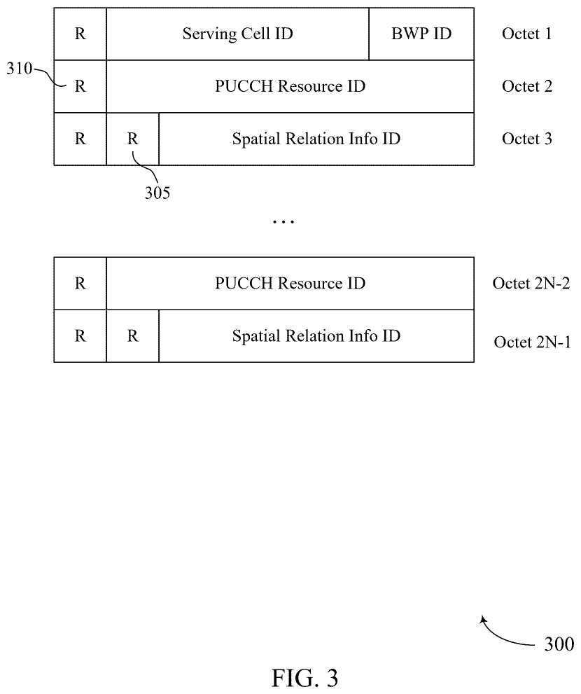

FIG. 3 shows an example of a MAC-CE diagram 300 that supports techniques for the configuration and activation of spatial relations for uplink channel communications in accordance with various aspects of the present disclosure. MAC-CE diagram 300 may illustrate a MAC-CE with various fields related to the activation of spatial relations for a PUCCH resource.

In this example, a network entity may transmit an RRC message to configure a spatial relation (i.e., spatial relation info ID) per PUCCH resource for SBFD operation for a UE. The RRC message may configure the spatial relation on a per PUCCH resource basis (i.e., per PUCCH resource ID). MAC-CE diagram 300 may include a plurality of PUCCH resource IDs with a plurality of respective spatial relation info IDs. MAC-CE diagram 300 may include a duplex type indicator 305 and a duplex type indicator 310. Duplex type indicator 305 may activate its respective spatial relation for its respective PUCCH resource for one of SBFD symbols, non-SBFD symbols, or both. Duplex indicator 310 may indicate whether its associated PUCCH resource is restricted to a duplex type indicated by duplex type indicator 305 or not.

In another example, in the absence of duplex type indicator 305 may indicate that the respective spatial relation is activated for both SBFD symbols and non-SBFD symbols.

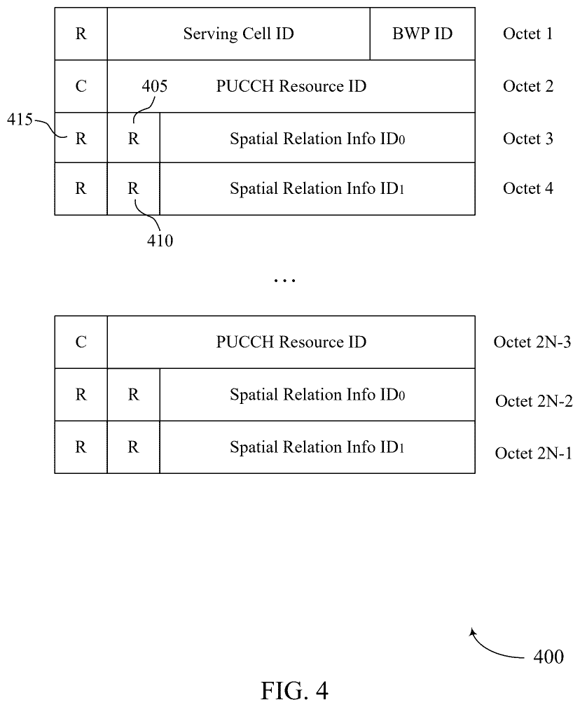

FIG. 4 shows an example of a MAC-CE diagram 400 that supports techniques for the configuration and activation of spatial relations for uplink channel communications in accordance with various aspects of the present disclosure. MAC-CE diagram 400 may illustrate a MAC-CE with various fields related to the activation of spatial relations for a PUCCH resource.

In this example, a network entity may transmit an RRC message to configure spatial relations (i.e., spatial relation info ID) per PUCCH resource for SBFD operation for a UE. The RRC message may configure the spatial relations on a per PUCCH resource basis (i.e., per PUCCH resource ID). MAC-CE diagram 400 may include a plurality of PUCCH resource IDs that are activated with a plurality of respective spatial relation info IDs. Here, each PUCCH resource may be associated with two spatial relations. In an example, a first spatial relation of the two spatial relations may be associated with a first duplex type and the second spatial relation of the two spatial relations may be associated with a second duplex type. The first duplex type and the second duplex type may be each individually associated with SBFD symbols, non-SBFD symbols, or both.

In an example, duplex type indicator 405 and duplex type indicator 410 may indicate a duplex type for its respective spatial relation. For example, a value of zero for a duplex type indicator may represent a non-SBFD duplex type and a value of one for a duplex type indicator may represent an SBFD duplex type.

In an example, duplex type indicator 405 may indicate whether a second spatial relation exists for the respective PUCCH resource. For example, a value of zero for duplex type indicator 405 may indicate that only one spatial relation is configured and that the spatial relation is associated with both non-SBFD duplex and SBFD duplex types. In another example, a value of one for duplex type indicator 405 may indicate that the second spatial relation exists for the respective PUCCH resource and the first spatial relation is associated with non-SBFD symbols and the second spatial relation is associated with SBFD symbols.

In an example, the duplex type of a respective spatial relation is determined by the order of the two spatial relations. For example, the first spatial relation is associated with non-SBFD symbols and the second spatial relation is associated with SBFD symbols.

In an example, duplex type indicator 405 may indicate whether a second spatial relation exists for the respective PUCCH resource. For example, a value of zero for duplex type indicator 405 may indicate that only one spatial relation is configured and that duplex type indicator 415 may indicate whether that spatial relation is applicable for SBFD or non-SBFD symbols. In another example, a value of one for duplex type indicator 405 may indicate that the second spatial relation exists for the respective PUCCH resource and the first spatial relation is associated with non-SBFD symbols and the second spatial relation is associated with SBFD symbols.

In an example, duplex type indicator 405 may indicate whether a second spatial relation exists for the respective PUCCH resource and what duplex types apply. For example, a value of zero for duplex type indicator 405 may indicate that only one spatial relation is configured and that the spatial relation is applicable for SBFD and non-SBFD symbols. In another example, a value of one for duplex type indicator 405 may indicate that the second spatial relation exists for the respective PUCCH resource and that duplex type indicator 410 may indicate the duplex type for each spatial relation. For example, if duplex type indicator 410 is zero, then the first spatial relation and the second spatial relation is applied to SBFD symbols, and if duplex type indicator 410 is one, then the first spatial relation of the two spatial relations is applied to SBFD symbols and the second spatial relation of the two spatial relations is applied to non-SBFD symbols.

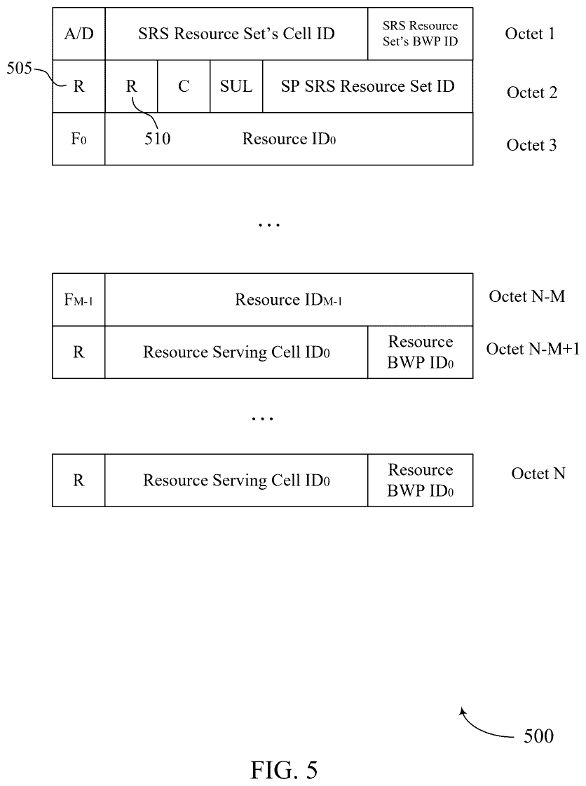

FIG. 5 shows an example of a MAC-CE diagram 500 that supports techniques for the configuration and activation of spatial relations for uplink channel communications in accordance with various aspects of the present disclosure. MAC-CE diagram 500 may illustrate a MAC-CE with various fields related to the activation of spatial relations for an SRS resource.

In an example, a network entity may transmit an RRC message to configure a spatial relation per periodic SRS resource for SBFD operation for a UE. The RRC message may configure the spatial relations on a per SRS resource basis (i.e., per resource IDᵢ). MAC-CE diagram 500 may include a resource ID with a respective spatial relation (in this example, a spatial relation may be represented by field, Fᵢ, for example, F₀). MAC-CE diagram 500 may include duplex type indicator 505 which activates a spatial relation for one of SBFD symbols, non-SBFD symbols, or both. In an example, if there is an absence of a duplex type indicator, the spatial relation may be activated for both SBFD symbols and non-SBFD symbols.

In an example, duplex type indicator 510 may indicate whether its associated SRS resource is restricted to one duplex symbol type or not, where duplex type indicator 505 may indicate the duplex type.

In an example, the RRC message may configure two spatial relations per SRS resource with each associated with a duplex type. The duplex type for each spatial relation may be explicitly indicated in the RRC message. In another example, the duplex type for each spatial relation may be based on an order of the spatial relations in the RRC message. For example, the first spatial relation may be for non-SBFD symbols and the second spatial relation may be for SBFD symbols. In another example, he first duplex type and the second duplex type may be each individually associated with SBFD symbols, non-SBFD symbols, or both.

In another example, the RRC message may configure one spatial relation per SRS resource where the spatial relation may be configured for both SBFD symbols or non-SBFD symbols. In another example, the spatial relation may only be configured for either SBFD symbols or non-SBFD symbols based on a duplex indicator restriction.

In another example, the RRC message may configure two spatial relations where each of the spatial relations are associated with separate SRS resources. In this example, each spatial relation may be associated with a respective duplex type indicator that indicates an association with SBFD symbols, non-SBFD symbols, or both.

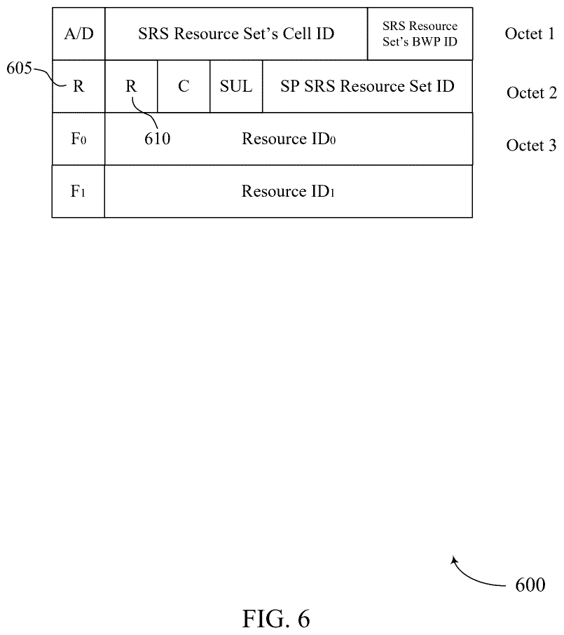

FIG. 6 shows an example of a MAC-CE diagram 600 that supports techniques for the configuration and activation of spatial relations for uplink channel communications in accordance with various aspects of the present disclosure. MAC-CE diagram 600 may illustrate a MAC-CE with various fields related to the activation of spatial relations for an SRS resource.

In an example, a network entity may transmit an RRC message to configure a spatial relation per semi-persistent SRS resource for SBFD operation for a UE. The RRC message may configure the spatial relations on a per SRS resource basis (i.e., per resource IDᵢ). MAC-CE diagram 600 may include a resource ID with a respective spatial relation (in this example, a spatial relation may be represented by field, Fᵢ, for example, F₀ and F₁). MAC-CE diagram 600 may include duplex type indicator 605 which activates a spatial relation for one of SBFD symbols, non-SBFD symbols, or both.

In an example, MAC-CE diagram 600 may include a plurality of resource IDs that are activated with respective spatial relations. Here, each resource ID may be associated with a spatial relation. In an example, a first spatial relation may be associated with a first duplex type and a second spatial relation may be associated with a second duplex type. In an example, duplex type indicator 605 and duplex type indicator 610 may indicate a duplex type for its respective spatial relation. For example, a value of zero for a duplex type indicator may represent a non-SBFD duplex type and a value of one for a duplex type indicator may represent an SBFD duplex type.

In an example, duplex type indicator 605 may indicate whether a second spatial relation exists for the respective SRS resource. For example, a value of zero for duplex type indicator 605 may indicate that only one spatial relation is configured and that the spatial relation is associated with both non-SBFD duplex and SBFD duplex types. In another example, a value of one for duplex type indicator 605 may indicate that the second spatial relation exists for the respective PUCCH resource and the first spatial relation is associated with non-SBFD symbols and the second spatial relation is associated with SBFD symbols.

In an example, the duplex type of a respective spatial relation is determined by the order of the two spatial relations. For example, the first spatial relation is associated with non-SBFD symbols and the second spatial relation is associated with SBFD symbols.

In an example, duplex type indicator 605 may indicate whether a second spatial relation exists for the respective PUCCH resource. For example, a value of zero for duplex type indicator 605 may indicate that only one spatial relation is configured and that duplex type indicator 615 may indicate whether that spatial relation is applicable for SBFD or non-SBFD symbols. In another example, a value of one for duplex type indicator 605 may indicate that the second spatial relation exists for the respective PUCCH resource and the first spatial relation is associated with non-SBFD symbols and the second spatial relation is associated with SBFD symbols.

In an example, duplex type indicator 605 may indicate whether a second spatial relation exists for the respective PUCCH resource and what duplex types apply. For example, a value of zero for duplex type indicator 605 may indicate that only one spatial relation is configured and that the spatial relation is applicable for SBFD and non-SBFD symbols. In another example, a value of one for duplex type indicator 605 may indicate that the second spatial relation exists for the respective PUCCH resource and that duplex type indicator 610 may indicate the duplex type for each spatial relation. For example, if duplex type indicator 610 is zero, then the first spatial relation and the second spatial relation is applied to SBFD symbols, and if duplex type indicator 610 is one, then the first spatial relation of the two spatial relations is applied to SBFD symbols and the second spatial relation of the two spatial relations is applied to non-SBFD symbols.

In an example, a network entity may transmit an RRC message to configure two spatial relations per aperiodic SRS resource for SBFD operation for a UE. In another example, each spatial relation may be associated with a respective duplex type that indicates an association with SBFD symbols, non-SBFD symbols, or both. In a further example, a UE may select one of the two spatial relations for application with the aperiodically triggered SRS resource based on a target slot type of the aperiodically triggered SRS resource.

In an example, a network entity may transmit an RRC message to configure two spatial relations per aperiodic SRS resource for SBFD operation for a UE. In another example, each spatial relation may be associated with a respective duplex type that indicates an association with SBFD symbols, non-SBFD symbols, or both. In a further example, a UE may select one of the two spatial relations for application with the aperiodically triggered SRS resource based on a duplex type indicator field included in a MAC-CE or DCI.

In an example, a network entity may transmit an RRC message to configure two spatial relations per aperiodic SRS resource for SBFD operation for a UE. In another example, each spatial relation may be associated with a respective duplex type that indicates an association with SBFD symbols, non-SBFD symbols, or both. In a further example, a UE may select one of the two spatial relations for application with the aperiodically triggered SRS resource based on a symbol type associated with the aperiodically triggered SRS resource.

In an example, a network entity may transmit an RRC message to configure a spatial relation per PUSCH resource for SBFD operation for a UE, where the PUSCH resource may be a Type 2 configured grant or a dynamic grant PUSCH resource. A network entity may also transmit a DCI which indicates an SRS resource indicator (SRI) with an associated spatial relation which is associated with a duplex type via a duplex type indicator. The duplex type may be individually associated with SBFD symbols, non-SBFD symbols, or both.

In an example, a network entity may transmit an RRC message to configure a spatial relation per PUSCH resource for SBFD operation for a UE, where the PUSCH resource may be a Type 2 configured grant or a dynamic grant PUSCH resource. A network entity may also transmit a DCI which indicates an SRI with an associated spatial relation which is associated with either of a first duplex type or both the first duplex type and a second duplex type via a duplex type indicator. The first and second duplex types may each be individually associated with SBFD symbols, non-SBFD symbols, or both.

In an example, a network entity may transmit an RRC message to configure two spatial relations per PUSCH resource for SBFD operation for a UE, where the PUSCH resource may be a Type 2 configured grant or a dynamic grant PUSCH resource. A network entity may also transmit a DCI which indicates two SRIs, with each SRI being associated with a respective spatial relation of the two spatial relations, with a first spatial relation being associated with a first duplex type and a second spatial relation being associated with a second duplex type. The first and second duplex types may each be individually associated with SBFD symbols, non-SBFD symbols, or both.

In an example, a network entity may transmit an RRC message to configure two spatial relations per PUSCH resource for SBFD operation for a UE, where the PUSCH resource may be a Type 1 configured grant. The RRC message may configure two SRIs where each SRI may indicate that a respective spatial relation is associated with a corresponding duplex type of the SRS resource.

In an example, a network entity may transmit an RRC message to configure two spatial relations per PUSCH resource for SBFD operation for a UE, where the PUSCH resource may be a Type 1 configured grant. The RRC message may configure one SRI which may indicate that the SRS resource is configured for each of the two spatial relations and that the spatial relations may be applicable to both SBFD symbols and non-SBFD symbols.

In an example, a network entity may transmit an RRC message to configure a spatial relation per PUSCH resource for SBFD operation for a UE, where the PUSCH resource may be a Type 1 configured grant. The RRC message may configure one SRI which may indicate that the SRS resource is configured for the spatial relation and that the spatial relation is associated with a duplex type based on a duplex indicator restriction in the RRC message.

In an example, a network entity may transmit an RRC message to configure a spatial relation per PUSCH resource for SBFD operation for a UE, where the PUSCH resource may be a Type 1 configured grant. The network entity may transmit a MAC-CE which activates the spatial relation for the PUSCH resource and includes a duplex type indicator which indicates that the spatial relation may be activated for SBFD symbols, non-SBFD symbols, or both.

In an example, a network entity may transmit an RRC message to configure two spatial relations per PUSCH resource for SBFD operation for a UE, where the PUSCH resource may be a Type 1 configured grant. The network entity may transmit a MAC-CE which activates each of the spatial relations for SBFD symbols, non-SBFD symbols, or both.

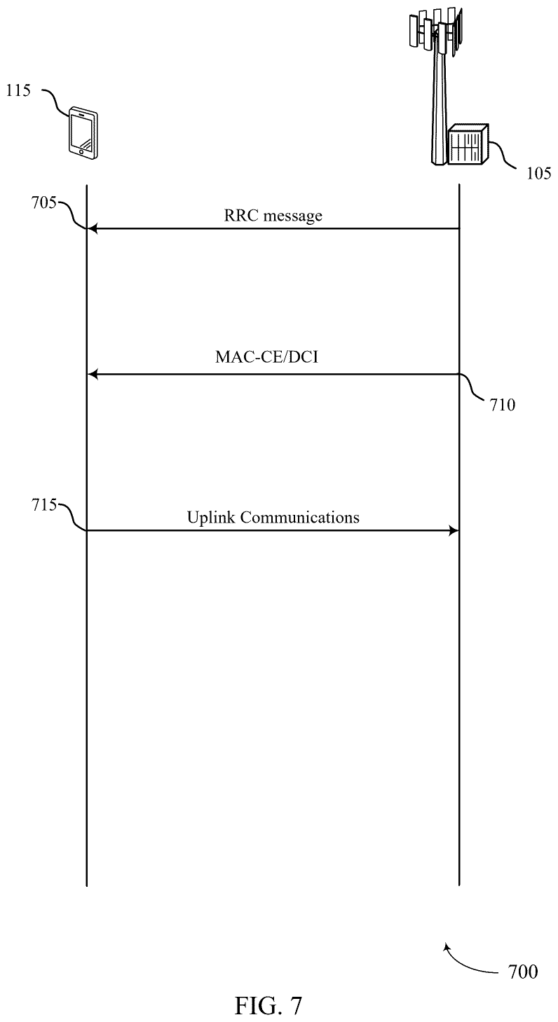

FIG. 7 shows an example of a process flow diagram 700 that supports techniques for the configuration and activation of spatial relations for uplink channel communications in accordance with one or more aspects of the present disclosure. Process flow diagram 700 may implement, or be implemented by, aspects of wireless communications system 100 or wireless communications system 200. For example, a UE 115 and a network entity 105 may communicate according to process flow diagram 700.

At 705, network entity 105 may transmit, and UE 115 may receive, an RRC message which may configure one or more spatial relations, each associated with a respective spatial reference, for uplink communications. The RRC message may also configure the one or more spatial relations for symbols associated with SBFD communications, non-SBFD communications, or both.

At 710, network entity 105 may transmit, and UE 115 may receive, either a MAC-CE or a DCI message which may activate the one or more spatial relations for one of a PUCCH resource, an SRS resource, or a PUSCH resource associated with the uplink communications. The one or more spatial relations may be activated symbols associated with SBFD communications, non-SBFD communications, or both.

At 715, UE 115 may transmit, and network entity 105 may receive, uplink communications via the PUCCH resource, the SRS resource, or the PUSCH resource. The uplink communications may be transmitted in accordance with the activated one or more spatial relations for symbols associated with SBFD communications, non-SBFD communications, or both.

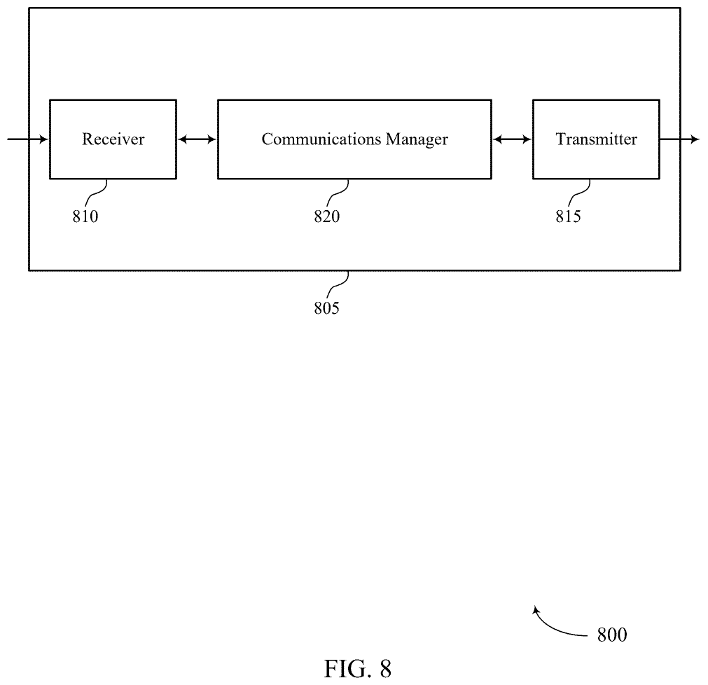

FIG. 8 shows a block diagram 800 of a device 805 that supports techniques for the configuration and activation of spatial relations for uplink channel communications in accordance with one or more aspects of the present disclosure. The device 805 may be an example of aspects of a UE 115 as described herein. The device 805 may include a receiver 810, a transmitter 815, and a communications manager 820. The device 805, or one or more components of the device 805 (e.g., the receiver 810, the transmitter 815, the communications manager 820), may include at least one processor, which may be coupled with at least one memory, to, individually or collectively, support or enable the described techniques. Each of these components may be in communication with one another (e.g., via one or more buses).

The receiver 810 may provide a means for receiving information such as packets, user data, control information, or any combination thereof associated with various information channels (e.g., control channels, data channels, information channels related to techniques for the configuration and activation of spatial relations for uplink channel communications). Information may be passed on to other components of the device 805. The receiver 810 may utilize a single antenna or a set of multiple antennas.

The transmitter 815 may provide a means for transmitting signals generated by other components of the device 805. For example, the transmitter 815 may transmit information such as packets, user data, control information, or any combination thereof associated with various information channels (e.g., control channels, data channels, information channels related to techniques for the configuration and activation of spatial relations for uplink channel communications). In some examples, the transmitter 815 may be co-located with a receiver 810 in a transceiver module. The transmitter 815 may utilize a single antenna or a set of multiple antennas.

The communications manager 820, the receiver 810, the transmitter 815, or various combinations or components thereof may be examples of means for performing various aspects of techniques for the configuration and activation of spatial relations for uplink channel communications as described herein. For example, the communications manager 820, the receiver 810, the transmitter 815, or various combinations or components thereof may be capable of performing one or more of the functions described herein.

In some examples, the communications manager 820, the receiver 810, the transmitter 815, or various combinations or components thereof may be implemented in hardware (e.g., in communications management circuitry). The hardware may include at least one of a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 820, the receiver 810, the transmitter 815, or various combinations or components thereof may be implemented in code (e.g., as communications management software or firmware) executed by at least one processor (e.g., referred to as a processor-executable code). If implemented in code executed by at least one processor, the functions of the communications manager 820, the receiver 810, the transmitter 815, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 820 may be configured to perform various operations (e.g., receiving, obtaining, monitoring, outputting, transmitting) using or otherwise in cooperation with the receiver 810, the transmitter 815, or both. For example, the communications manager 820 may receive information from the receiver 810, send information to the transmitter 815, or be integrated in combination with the receiver 810, the transmitter 815, or both to obtain information, output information, or perform various other operations as described herein.

The communications manager 820 may support wireless communications in accordance with examples as disclosed herein. For example, the communications manager 820 is capable of, configured to, or operable to support a means for receiving first information that configures one or more spatial relations for uplink communications. The communications manager 820 is capable of, configured to, or operable to support a means for receiving second information that activates the one or more spatial relations, the one or more spatial relations each associated with a respective spatial reference for one of a PUCCH resource, an SRS resource, or an PUSCH resource, and where the second information activates the one or more spatial relations for sub-band full duplex (SBFD) symbols, non-SBFD symbols, or both. The communications manager 820 is capable of, configured to, or operable to support a means for transmitting the uplink communications via the PUCCH resource, the SRS resource, or the PUSCH resource in accordance with the activated one or more spatial relations for the SBFD symbols, the non-SBFD symbols, or both.

By including or configuring the communications manager 820 in accordance with examples as described herein, the device 805 (e.g., at least one processor controlling or otherwise coupled with the receiver 810, the transmitter 815, the communications manager 820, or a combination thereof) may support techniques for the configuration and activation of spatial relations for uplink channel communications resulting in reduced interference and enhanced signal gains.

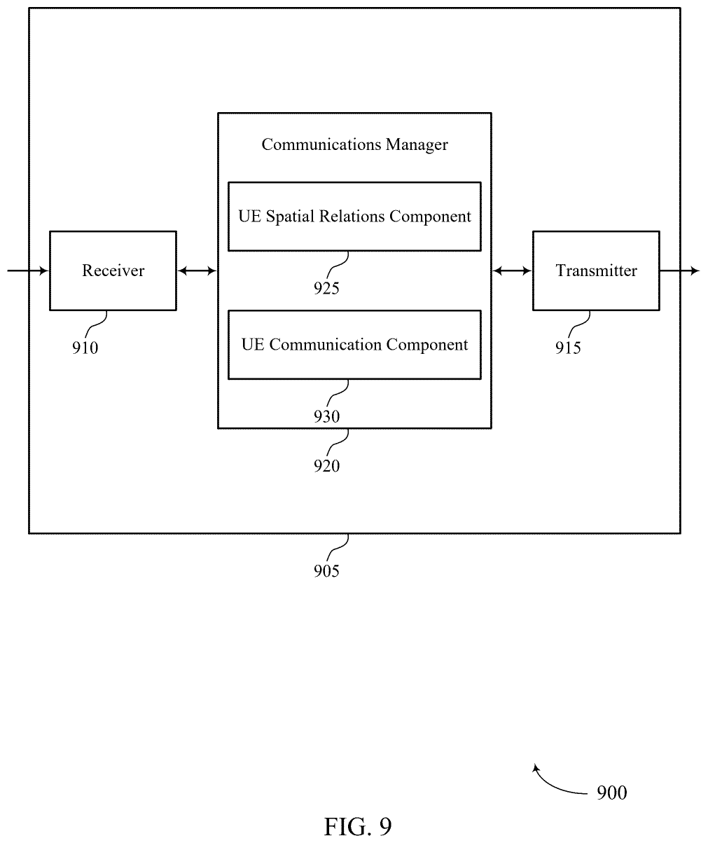

FIG. 9 shows a block diagram 900 of a device 905 that supports techniques for the configuration and activation of spatial relations for uplink channel communications in accordance with one or more aspects of the present disclosure. The device 905 may be an example of aspects of a device 805 or a UE 115 as described herein. The device 905 may include a receiver 910, a transmitter 915, and a communications manager 920. The device 905, or one of more components of the device 905 (e.g., the receiver 910, the transmitter 915, the communications manager 920), may include at least one processor, which may be coupled with at least one memory, to support the described techniques. Each of these components may be in communication with one another (e.g., via one or more buses).

The receiver 910 may provide a means for receiving information such as packets, user data, control information, or any combination thereof associated with various information channels (e.g., control channels, data channels, information channels related to techniques for the configuration and activation of spatial relations for uplink channel communications). Information may be passed on to other components of the device 905. The receiver 910 may utilize a single antenna or a set of multiple antennas.

The transmitter 915 may provide a means for transmitting signals generated by other components of the device 905. For example, the transmitter 915 may transmit information such as packets, user data, control information, or any combination thereof associated with various information channels (e.g., control channels, data channels, information channels related to techniques for the configuration and activation of spatial relations for uplink channel communications). In some examples, the transmitter 915 may be co-located with a receiver 910 in a transceiver module. The transmitter 915 may utilize a single antenna or a set of multiple antennas.

The device 905, or various components thereof, may be an example of means for performing various aspects of techniques for the configuration and activation of spatial relations for uplink channel communications as described herein. For example, the communications manager 920 may include a UE spatial relations component 925 a UE communication component 930, or any combination thereof. The communications manager 920 may be an example of aspects of a communications manager 820 as described herein. In some examples, the communications manager 920, or various components thereof, may be configured to perform various operations (e.g., receiving, obtaining, monitoring, outputting, transmitting) using or otherwise in cooperation with the receiver 910, the transmitter 915, or both. For example, the communications manager 920 may receive information from the receiver 910, send information to the transmitter 915, or be integrated in combination with the receiver 910, the transmitter 915, or both to obtain information, output information, or perform various other operations as described herein.

The communications manager 920 may support wireless communications in accordance with examples as disclosed herein. The UE spatial relations component 925 is capable of, configured to, or operable to support a means for receiving first information that configures one or more spatial relations for uplink communications. The UE spatial relations component 925 is capable of, configured to, or operable to support a means for receiving second information that activates the one or more spatial relations, the one or more spatial relations each associated with a respective spatial reference for one of a PUCCH resource, an SRS resource, or an PUSCH resource, and where the second information activates the one or more spatial relations for sub-band full duplex (SBFD) symbols, non-SBFD symbols, or both. The UE communication component 930 is capable of, configured to, or operable to support a means for transmitting the uplink communications via the PUCCH resource, the SRS resource, or the PUSCH resource in accordance with the activated one or more spatial relations for the SBFD symbols, the non-SBFD symbols, or both.

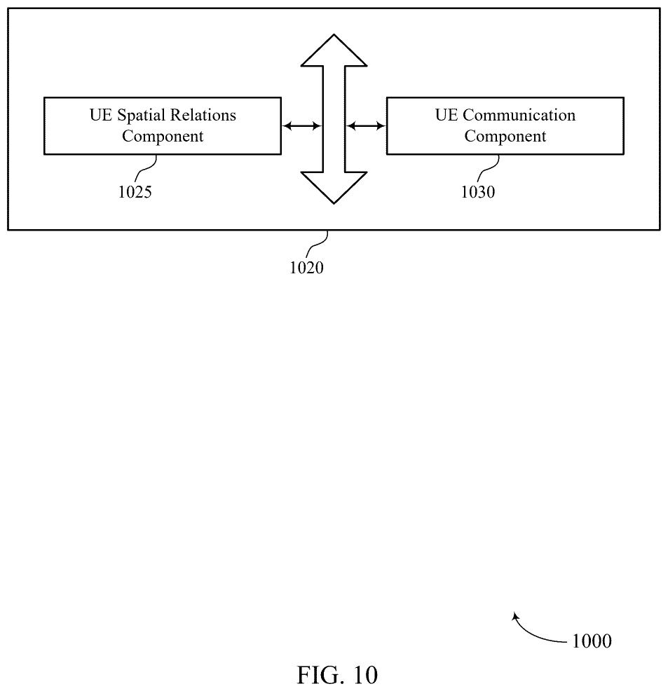

FIG. 10 shows a block diagram 1000 of a communications manager 1020 that supports techniques for the configuration and activation of spatial relations for uplink channel communications in accordance with one or more aspects of the present disclosure. The communications manager 1020 may be an example of aspects of a communications manager 820, a communications manager 920, or both, as described herein. The communications manager 1020, or various components thereof, may be an example of means for performing various aspects of techniques for the configuration and activation of spatial relations for uplink channel communications as described herein. For example, the communications manager 1020 may include a UE spatial relations component 1025 a UE communication component 1030, or any combination thereof. Each of these components, or components or subcomponents thereof (e.g., one or more processors, one or more memories), may communicate, directly or indirectly, with one another (e.g., via one or more buses).

The communications manager 1020 may support wireless communications in accordance with examples as disclosed herein. The UE spatial relations component 1025 is capable of, configured to, or operable to support a means for receiving first information that configures one or more spatial relations for uplink communications. In some examples, the UE spatial relations component 1025 is capable of, configured to, or operable to support a means for receiving second information that activates the one or more spatial relations, the one or more spatial relations each associated with a respective spatial reference for one of a PUCCH resource, an SRS resource, or an PUSCH resource, and where the second information activates the one or more spatial relations for sub-band full duplex (SBFD) symbols, non-SBFD symbols, or both. The UE communication component 1030 is capable of, configured to, or operable to support a means for transmitting the uplink communications via the PUCCH resource, the SRS resource, or the PUSCH resource in accordance with the activated one or more spatial relations for the SBFD symbols, the non-SBFD symbols, or both.

In some examples, the first information configures, for the PUCCH resource and on a per PUCCH resource basis, a first spatial relation of the one or more spatial relations. In some examples, the second information includes a first duplex type indicator that activates the first spatial relation for one of the SBFD symbols, the non-SBFD symbols, or both.

In some examples, the second information includes a second duplex type indicator that indicates whether the PUCCH resource is restricted to a duplex type indicated by the first duplex type indicator or not.

In some examples, the first information configures, for the PUCCH resource and on a per PUCCH resource basis, a first spatial relation of the one or more spatial relations. In some examples, an absence of a first duplex type indicator in the second information indicates that the first spatial relation is activated for both the SBFD symbols and the non-SBFD symbols.

In some examples, the first information configures, for the PUCCH resource and on a per PUCCH resource basis, at least one of a first spatial relation of the one or more spatial relations and a second spatial relation of the one or more spatial relations. In some examples, the first spatial relation is associated with a first duplex type and the second spatial relation is associated with a second duplex type. In some examples, the first duplex type and the second duplex type are individually associated with the SBFD symbols, the non-SBFD symbols, or both.

In some examples, the second information includes both a first duplex type indicator that indicates that the first spatial relation is associated with the first duplex type and a second duplex type indicator that indicates that the second spatial relation is associated with the second duplex type.

In some examples, the second information includes a spatial relation quantity indicator that indicates that only the first spatial relation is configured and that the first spatial relation is associated with both the first duplex type and the second duplex type.

In some examples, the second information includes a spatial relation quantity indicator that indicates that both the first spatial relation and the second spatial relation are configured. In some examples, association of the first spatial relation with the first duplex type and of the second spatial relation with the second duplex type is based on an order of the first spatial relation and the second spatial relation in the second information.

In some examples, association of the first spatial relation with the first duplex type and of the second spatial relation with the second duplex type is based on an order of the first spatial relation and the second spatial relation in the second information.

In some examples, the second information includes a spatial relation quantity indicator that indicates that only the first spatial relation is configured. In some examples, the second information further includes a first duplex type indicator that indicates that the first spatial relation is associated with the first duplex type.

In some examples, the second information includes a first duplex type indicator that indicates that the first spatial relation is associated with both the first duplex type and the second duplex type. In some examples, indication that the first spatial relation is associated with both the first duplex type and the second duplex type is indicative that only the first spatial relation is configured.

In some examples, the second information includes a first duplex type indicator that indicates that the first spatial relation and the second spatial relation are associated with different duplex types. In some examples, the second information includes a second duplex type indicator that indicates that the first spatial relation is associated with the first duplex type and that the second spatial relation is associated with the second duplex type.

In some examples, the first information configures, for the SRS resource and on a per periodic SRS resource basis, a first spatial relation of the one or more spatial relations and a second spatial relation of the one or more spatial relations. In some examples, the first spatial relation is associated with a first duplex type and the second spatial relation is associated with a second duplex type. In some examples, association of the first spatial relation with the first duplex type and of the second spatial relation with the second duplex type is based on explicit indication in the first information or on an order of the first spatial relation and the second spatial relation in the first information. In some examples, the first duplex type and the second duplex type are individually associated with the SBFD symbols, the non-SBFD symbols, or both.

In some examples, the first information configures, for the SRS resource and on a per periodic SRS resource basis, a first spatial relation of the one or more spatial relations. In some examples, the first spatial relation is associated with both a first duplex type and a second duplex type or is associated, based on a duplex indicator restriction, with only one of the first duplex type or the second duplex type. In some examples, the first duplex type and the second duplex type are individually associated with the SBFD symbols, the non-SBFD symbols, or both.

In some examples, the first information configures, for a first SRS resource and on a per periodic SRS resource basis, a first spatial relation of the one or more spatial relations, and for a second SRS resource, a second spatial relation of the one or more spatial relations. In some examples, the SRS resource is one of the first SRS resource or the second SRS resource. In some examples, each of the first spatial relation and the second spatial relation is associated with a respective duplex type indicator that indicates an association with the SBFD symbols, the non-SBFD symbols, or both.

In some examples, the first information configures, for the SRS resource and on a per semi-persistent SRS resource basis, a first spatial relation of the one or more spatial relations. In some examples, the second information includes a first duplex type indicator that activates the first spatial relation for one of the SBFD symbols, the non-SBFD symbols, or both.

In some examples, the second information includes a second duplex type indicator that indicates whether the SRS resource is restricted to a duplex type indicated by the first duplex type indicator or not.

In some examples, the first information configures, for the SRS resource and on a per semi-persistent SRS resource basis, a first spatial relation of the one or more spatial relations. In some examples, an absence of a first duplex type indicator in the second information indicates that the first spatial relation is activated for both the SBFD symbols and the non-SBFD symbols.

In some examples, the first information configures, for the SRS resource and on a per semi-persistent SRS resource basis, at least one of a first spatial relation of the one or more spatial relations and a second spatial relation of the one or more spatial relations. In some examples, the first spatial relation is associated with a first duplex type and the second spatial relation is associated with a second duplex type. In some examples, the first duplex type and the second duplex type are individually associated with the SBFD symbols, the non-SBFD symbols, or both.

In some examples, the second information includes both a first duplex type indicator that indicates that the first spatial relation is associated with the first duplex type and a second duplex type indicator that indicates that the second spatial relation is associated with the second duplex type.

In some examples, the second information includes a spatial relation quantity indicator that indicates that only the first spatial relation is configured and that the first spatial relation is associated with both the first duplex type and the second duplex type.

In some examples, the second information includes a spatial relation quantity indicator that indicates that both the first spatial relation and the second spatial relation are configured. In some examples, association of the first spatial relation with the first duplex type and of the second spatial relation with the second duplex type is based on an order of the first spatial relation and the second spatial relation in the second information.

In some examples, association of the first spatial relation with the first duplex type and of the second spatial relation with the second duplex type is based on an order of the first spatial relation and the second spatial relation in the second information.

In some examples, the second information includes a spatial relation quantity indicator that indicates that only the first spatial relation is configured. In some examples, the second information further includes a first duplex type indicator that indicates that the first spatial relation is associated with the first duplex type.

In some examples, the second information includes a first duplex type indicator that indicates that the first spatial relation is associated with both the first duplex type and the second duplex type. In some examples, indication that the first spatial relation is associated with both the first duplex type and the second duplex type is indicative that only the first spatial relation is configured.

In some examples, the second information includes a first duplex type indicator that indicates that the first spatial relation and the second spatial relation are associated with different duplex types. In some examples, the second information includes a second duplex type indicator that indicates that the first spatial relation is associated with the first duplex type and that the second spatial relation is associated with the second duplex type.

In some examples, the first information configures, and the UE spatial relations component 1025 is capable of, configured to, or operable to support a means for selecting one of the first spatial relation or the second spatial relation for application with the aperiodically triggered SRS resource, where the selection is based on a target slot type of the aperiodically triggered SRS resource.

In some examples, the first information configures, and the UE spatial relations component 1025 is capable of, configured to, or operable to support a means for selecting one of the first spatial relation or the second spatial relation for application with the aperiodically triggered SRS resource, where the selection is based on a duplex type indicator field included in the second information.

In some examples, the first information configures, and the UE spatial relations component 1025 is capable of, configured to, or operable to support a means for selecting one of the first spatial relation or the second spatial relation for application with the aperiodically triggered SRS resource, where the selection is based on a symbol type associated with the aperiodically triggered SRS resource.

In some examples, the second information includes a downlink control information which indicates, for the PUSCH resource, a first SRS resource indicator (SRI) that includes at least a first spatial relation of the one or more spatial relations. In some examples, the first spatial relation is associated with a first duplex type via a duplex type indicator. In some examples, the PUSCH resource is a Type 2 configured grant or a dynamic grant PUSCH resource and. In some examples, the first duplex type is individually associated with the SBFD symbols, the non-SBFD symbols, or both.

In some examples, the second information includes a downlink control information which indicates, for the PUSCH resource, a first SRS resource indicator (SRI) that includes a first spatial relation of the one or more spatial relations. In some examples, the first spatial relation is associated with either a first duplex type or both the first duplex type and a second duplex type. In some examples, the PUSCH resource is a Type 2 configured grant or a dynamic grant PUSCH resource and. In some examples, the first duplex type and the second duplex type are individually associated with the SBFD symbols, the non-SBFD symbols, or both.

In some examples, the second information includes a downlink control information which indicates, for the PUSCH resource, a first SRS resource indicator (SRI) that includes a first spatial relation of the one or more spatial relations and a second SRI that includes a second spatial relation of the one or more spatial relations. In some examples, the first spatial relation is associated with a first duplex type and the second spatial relation is associated with a second duplex type. In some examples, the PUSCH resource is a Type 2 configured grant or a dynamic grant PUSCH resource. In some examples, the first duplex type and the second duplex type are individually associated with the SBFD symbols, the non-SBFD symbols, or both.

In some examples, the first information configures, for the PUSCH resource and on a per PUSCH resource basis, at least one of a first SRS resource indicator (SRI) and a second SRI, each of the first SRI and the second SRI indicating the one or more spatial relations associated with a duplex type of the SRS resource. In some examples, the PUSCH resource is a Type 1 configured grant.

In some examples, the first information configures an SRS resource indicator for the PUSCH resource on a per PUSCH resource basis. In some examples, the SRI indicates that the SRS resource is configured with a first spatial relation of the one or more spatial relations and a second SRI that includes a second spatial relation of the one or more spatial relations for both the SBFD symbols and the non-SBFD symbols. In some examples, the PUSCH resource is a Type 1 configured grant.

In some examples, the first information configures an SRS resource indicator for the PUSCH resource on a per PUSCH resource basis. In some examples, the SRI indicates that the SRS resource is configured with a first spatial relation of the one or more spatial relations associated with a duplex type based on a duplex indicator restriction.

In some examples, the first information configures, for the PUSCH resource and on a per PUSCH resource basis, a first spatial relation of the one or more spatial relations and a second spatial relation of the one or more spatial relations. In some examples, the second information activates the first spatial relation for the PUSCH resource. In some examples, the first spatial relation is associated with a first duplex type via a duplex type indicator, the first duplex type being individually associated with the SBFD symbols, the non-SBFD symbols, or both. In some examples, the PUSCH resource is a Type 1 configured grant.

In some examples, the first information configures, for the PUSCH resource and on a per PUSCH resource basis, a first spatial relation of the one or more spatial relations and a second spatial relation of the one or more spatial relations. In some examples, the second information activates the first spatial relation and the second spatial relation for the PUSCH resource. In some examples, the first spatial relation is associated with a first duplex type and the second spatial relation is associated with a second duplex type. In some examples, the first duplex type and the second duplex type are individually associated with the SBFD symbols, the non-SBFD symbols, or both. In some examples, the PUSCH resource is a Type 1 configured grant.

In some examples, the first information includes a radio resource control message. In some examples, the second information includes a medium access control control element or a downlink control information.

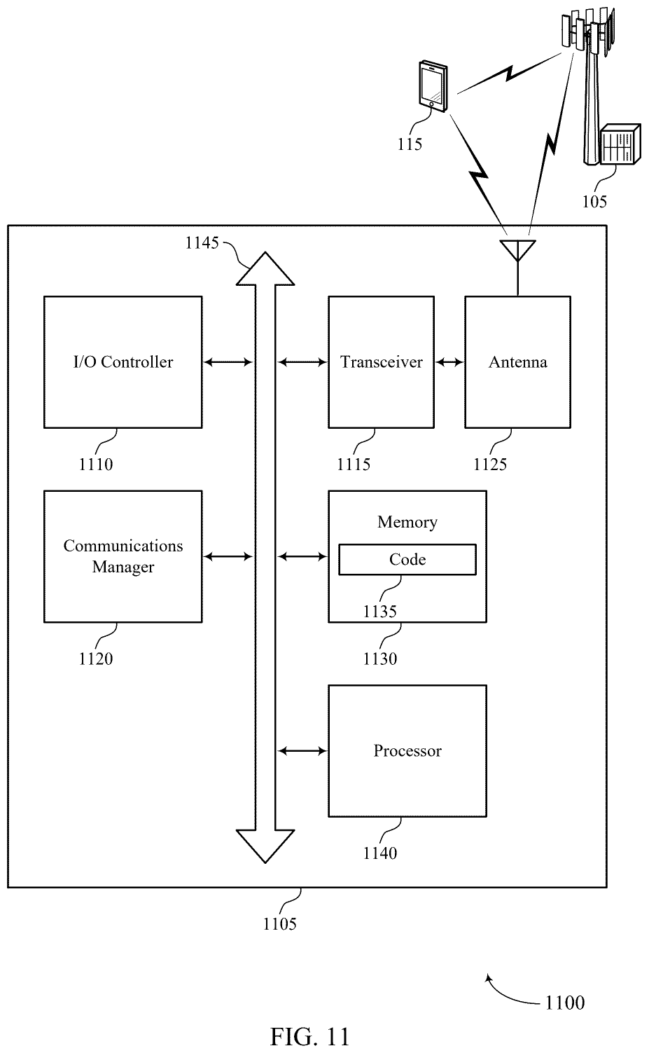

FIG. 11 shows a diagram of a system 1100 including a device 1105 that supports techniques for the configuration and activation of spatial relations for uplink channel communications in accordance with one or more aspects of the present disclosure. The device 1105 may be an example of or include components of a device 805, a device 905, or a UE 115 as described herein. The device 1105 may communicate (e.g., wirelessly) with one or more other devices (e.g., network entities 105, UEs 115, or a combination thereof). The device 1105 may include components for bi-directional voice and data communications including components for transmitting and receiving communications, such as a communications manager 1120, an input/output (I/O) controller, such as an I/O controller 1110, a transceiver 1115, one or more antennas 1125, at least one memory 1130, code 1135, and at least one processor 1140. These components may be in electronic communication or otherwise coupled (e.g., operatively, communicatively, functionally, electronically, electrically) via one or more buses (e.g., a bus 1145).

The I/O controller 1110 may manage input and output signals for the device 1105. The I/O controller 1110 may also manage peripherals not integrated into the device 1105. In some cases, the I/O controller 1110 may represent a physical connection or port to an external peripheral. In some cases, the I/O controller 1110 may utilize an operating system such as iOS®, ANDROID®, MS-DOS®, MS-WINDOWS®, OS/2®, UNIX®, LINUX®, or another known operating system. Additionally, or alternatively, the I/O controller 1110 may represent or interact with a modem, a keyboard, a mouse, a touchscreen, or a similar device. In some cases, the I/O controller 1110 may be implemented as part of one or more processors, such as the at least one processor 1140. In some cases, a user may interact with the device 1105 via the I/O controller 1110 or via hardware components controlled by the I/O controller 1110.

In some cases, the device 1105 may include a single antenna. However, in some other cases, the device 1105 may have more than one antenna, which may be capable of concurrently transmitting or receiving multiple wireless transmissions. The transceiver 1115 may communicate bi-directionally via the one or more antennas 1125 using wired or wireless links as described herein. For example, the transceiver 1115 may represent a wireless transceiver and may communicate bi-directionally with another wireless transceiver. The transceiver 1115 may also include a modem to modulate the packets, to provide the modulated packets to one or more antennas 1125 for transmission, and to demodulate packets received from the one or more antennas 1125. The transceiver 1115, or the transceiver 1115 and one or more antennas 1125, may be an example of a transmitter 815, a transmitter 915, a receiver 810, a receiver 910, or any combination thereof or component thereof, as described herein.

The at least one memory 1130 may include random access memory (RAM) and read-only memory (ROM). The at least one memory 1130 may store computer-readable, computer-executable, or processor-executable code, such as the code 1135. The code 1135 may include instructions that, when executed by the at least one processor 1140, cause the device 1105 to perform various functions described herein. The code 1135 may be stored in a non-transitory computer-readable medium such as system memory or another type of memory. In some cases, the code 1135 may not be directly executable by the at least one processor 1140 but may cause a computer (e.g., when compiled and executed) to perform functions described herein. In some cases, the at least one memory 1130 may include, among other things, a basic I/O system (BIOS) which may control basic hardware or software operation such as the interaction with peripheral components or devices.

The at least one processor 1140 may include one or more intelligent hardware devices (e.g., one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 1140 may be configured to operate a memory array using a memory controller. In some other cases, a memory controller may be integrated into the at least one processor 1140. The at least one processor 1140 may be configured to execute computer-readable instructions stored in a memory (e.g., the at least one memory 1130) to cause the device 1105 to perform various functions (e.g., functions or tasks supporting techniques for the configuration and activation of spatial relations for uplink channel communications). For example, the device 1105 or a component of the device 1105 may include at least one processor 1140 and at least one memory 1130 coupled with or to the at least one processor 1140, the at least one processor 1140 and the at least one memory 1130 configured to perform various functions described herein.

In some examples, the at least one processor 1140 may include multiple processors and the at least one memory 1130 may include multiple memories. One or more of the multiple processors may be coupled with one or more of the multiple memories, which may, individually or collectively, be configured to perform various functions described herein. In some examples, the at least one processor 1140 may be a component of a processing system, which may refer to a system (such as a series) of machines, circuitry (including, for example, one or both of processor circuitry (which may include the at least one processor 1140) and memory circuitry (which may include the at least one memory 1130)), or components, that receives or obtains inputs and processes the inputs to produce, generate, or obtain a set of outputs. The processing system may be configured to perform one or more of the functions described herein. For example, the at least one processor 1140 or a processing system including the at least one processor 1140 may be configured to, configurable to, or operable to cause the device 1105 to perform one or more of the functions described herein. Further, as described herein, being “configured to,” being “configurable to,” and being “operable to” may be used interchangeably and may be associated with a capability, when executing code 1135 (e.g., processor-executable code) stored in the at least one memory 1130 or otherwise, to perform one or more of the functions described herein.

The communications manager 1120 may support wireless communications in accordance with examples as disclosed herein. For example, the communications manager 1120 is capable of, configured to, or operable to support a means for receiving first information that configures one or more spatial relations for uplink communications. The communications manager 1120 is capable of, configured to, or operable to support a means for receiving second information that activates the one or more spatial relations, the one or more spatial relations each associated with a respective spatial reference for one of a PUCCH resource, an SRS resource, or an PUSCH resource, and where the second information activates the one or more spatial relations for sub-band full duplex (SBFD) symbols, non-SBFD symbols, or both. The communications manager 1120 is capable of, configured to, or operable to support a means for transmitting the uplink communications via the PUCCH resource, the SRS resource, or the PUSCH resource in accordance with the activated one or more spatial relations for the SBFD symbols, the non-SBFD symbols, or both.

By including or configuring the communications manager 1120 in accordance with examples as described herein, the device 1105 may support techniques for the configuration and activation of spatial relations for uplink channel communications resulting in reduced interference and enhanced signal gains.

In some examples, the communications manager 1120 may be configured to perform various operations (e.g., receiving, monitoring, transmitting) using or otherwise in cooperation with the transceiver 1115, the one or more antennas 1125, or any combination thereof. Although the communications manager 1120 is illustrated as a separate component, in some examples, one or more functions described with reference to the communications manager 1120 may be supported by or performed by the at least one processor 1140, the at least one memory 1130, the code 1135, or any combination thereof. For example, the code 1135 may include instructions executable by the at least one processor 1140 to cause the device 1105 to perform various aspects of techniques for the configuration and activation of spatial relations for uplink channel communications as described herein, or the at least one processor 1140 and the at least one memory 1130 may be otherwise configured to, individually or collectively, perform or support such operations.

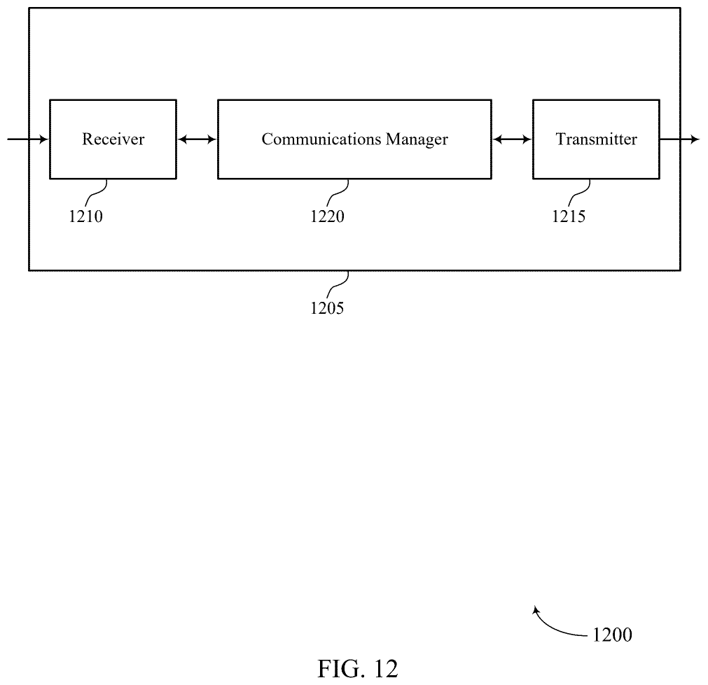

FIG. 12 shows a block diagram 1200 of a device 1205 that supports techniques for the configuration and activation of spatial relations for uplink channel communications in accordance with one or more aspects of the present disclosure. The device 1205 may be an example of aspects of a network entity 105 as described herein. The device 1205 may include a receiver 1210, a transmitter 1215, and a communications manager 1220. The device 1205, or one or more components of the device 1205 (e.g., the receiver 1210, the transmitter 1215, the communications manager 1220), may include at least one processor, which may be coupled with at least one memory, to, individually or collectively, support or enable the described techniques. Each of these components may be in communication with one another (e.g., via one or more buses).

The receiver 1210 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1205. In some examples, the receiver 1210 may support obtaining information by receiving signals via one or more antennas. Additionally, or alternatively, the receiver 1210 may support obtaining information by receiving signals via one or more wired (e.g., electrical, fiber optic) interfaces, wireless interfaces, or any combination thereof.

The transmitter 1215 may provide a means for outputting (e.g., transmitting, providing, conveying, sending) information generated by other components of the device 1205. For example, the transmitter 1215 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1215 may support outputting information by transmitting signals via one or more antennas. Additionally, or alternatively, the transmitter 1215 may support outputting information by transmitting signals via one or more wired (e.g., electrical, fiber optic) interfaces, wireless interfaces, or any combination thereof. In some examples, the transmitter 1215 and the receiver 1210 may be co-located in a transceiver, which may include or be coupled with a modem.

The communications manager 1220, the receiver 1210, the transmitter 1215, or various combinations or components thereof may be examples of means for performing various aspects of techniques for the configuration and activation of spatial relations for uplink channel communications as described herein. For example, the communications manager 1220, the receiver 1210, the transmitter 1215, or various combinations or components thereof may be capable of performing one or more of the functions described herein.

In some examples, the communications manager 1220, the receiver 1210, the transmitter 1215, or various combinations or components thereof may be implemented in hardware (e.g., in communications management circuitry). The hardware may include at least one of a processor, a DSP, a CPU, an ASIC, an FPGA or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 1220, the receiver 1210, the transmitter 1215, or various combinations or components thereof may be implemented in code (e.g., as communications management software or firmware) executed by at least one processor (e.g., referred to as a processor-executable code). If implemented in code executed by at least one processor, the functions of the communications manager 1220, the receiver 1210, the transmitter 1215, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 1220 may be configured to perform various operations (e.g., receiving, obtaining, monitoring, outputting, transmitting) using or otherwise in cooperation with the receiver 1210, the transmitter 1215, or both. For example, the communications manager 1220 may receive information from the receiver 1210, send information to the transmitter 1215, or be integrated in combination with the receiver 1210, the transmitter 1215, or both to obtain information, output information, or perform various other operations as described herein.

The communications manager 1220 may support wireless communications in accordance with examples as disclosed herein. For example, the communications manager 1220 is capable of, configured to, or operable to support a means for transmitting first information that configures one or more spatial relations for a PUCCH, an SRS, or an PUSCH resource. The communications manager 1220 is capable of, configured to, or operable to support a means for transmitting second information that activates the one or two respective spatial relations for sub-band full duplex (SBFD) symbols, non-SBFD symbols, or both. The communications manager 1220 is capable of, configured to, or operable to support a means for receiving an uplink communication that uses the PUCCH, SRS, or PUSCH resource in accordance with the activated one or two spatial relations for the SBFD symbols, the non-SBFD symbols, or both.

By including or configuring the communications manager 1220 in accordance with examples as described herein, the device 1205 (e.g., at least one processor controlling or otherwise coupled with the receiver 1210, the transmitter 1215, the communications manager 1220, or a combination thereof) may support techniques for the configuration and activation of spatial relations for uplink channel communications resulting in reduced interference and enhanced signal gains.

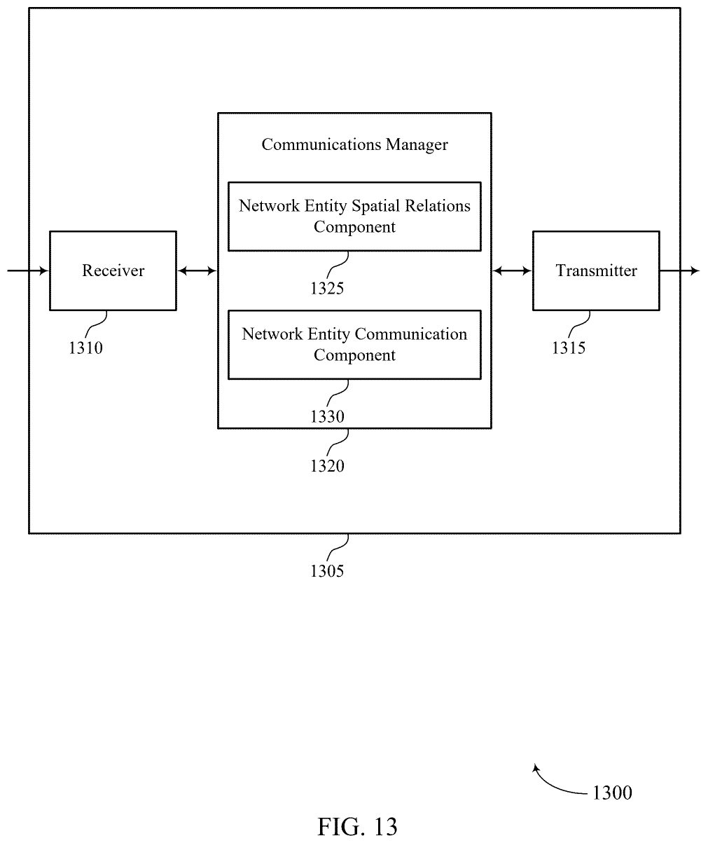

FIG. 13 shows a block diagram 1300 of a device 1305 that supports techniques for the configuration and activation of spatial relations for uplink channel communications in accordance with one or more aspects of the present disclosure. The device 1305 may be an example of aspects of a device 1205 or a network entity 105 as described herein. The device 1305 may include a receiver 1310, a transmitter 1315, and a communications manager 1320. The device 1305, or one of more components of the device 1305 (e.g., the receiver 1310, the transmitter 1315, the communications manager 1320), may include at least one processor, which may be coupled with at least one memory, to support the described techniques. Each of these components may be in communication with one another (e.g., via one or more buses).

The receiver 1310 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1305. In some examples, the receiver 1310 may support obtaining information by receiving signals via one or more antennas. Additionally, or alternatively, the receiver 1310 may support obtaining information by receiving signals via one or more wired (e.g., electrical, fiber optic) interfaces, wireless interfaces, or any combination thereof.

The transmitter 1315 may provide a means for outputting (e.g., transmitting, providing, conveying, sending) information generated by other components of the device 1305. For example, the transmitter 1315 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1315 may support outputting information by transmitting signals via one or more antennas. Additionally, or alternatively, the transmitter 1315 may support outputting information by transmitting signals via one or more wired (e.g., electrical, fiber optic) interfaces, wireless interfaces, or any combination thereof. In some examples, the transmitter 1315 and the receiver 1310 may be co-located in a transceiver, which may include or be coupled with a modem.

The device 1305, or various components thereof, may be an example of means for performing various aspects of techniques for the configuration and activation of spatial relations for uplink channel communications as described herein. For example, the communications manager 1320 may include a network entity spatial relations component 1325 a network entity communication component 1330, or any combination thereof. The communications manager 1320 may be an example of aspects of a communications manager 1220 as described herein. In some examples, the communications manager 1320, or various components thereof, may be configured to perform various operations (e.g., receiving, obtaining, monitoring, outputting, transmitting) using or otherwise in cooperation with the receiver 1310, the transmitter 1315, or both. For example, the communications manager 1320 may receive information from the receiver 1310, send information to the transmitter 1315, or be integrated in combination with the receiver 1310, the transmitter 1315, or both to obtain information, output information, or perform various other operations as described herein.

The communications manager 1320 may support wireless communications in accordance with examples as disclosed herein. The network entity spatial relations component 1325 is capable of, configured to, or operable to support a means for transmitting first information that configures one or more spatial relations for a PUCCH, an SRS, or an PUSCH resource. The network entity spatial relations component 1325 is capable of, configured to, or operable to support a means for transmitting second information that activates the one or two respective spatial relations for sub-band full duplex (SBFD) symbols, non-SBFD symbols, or both. The network entity communication component 1330 is capable of, configured to, or operable to support a means for receiving an uplink communication that uses the PUCCH, SRS, or PUSCH resource in accordance with the activated one or two spatial relations for the SBFD symbols, the non-SBFD symbols, or both.

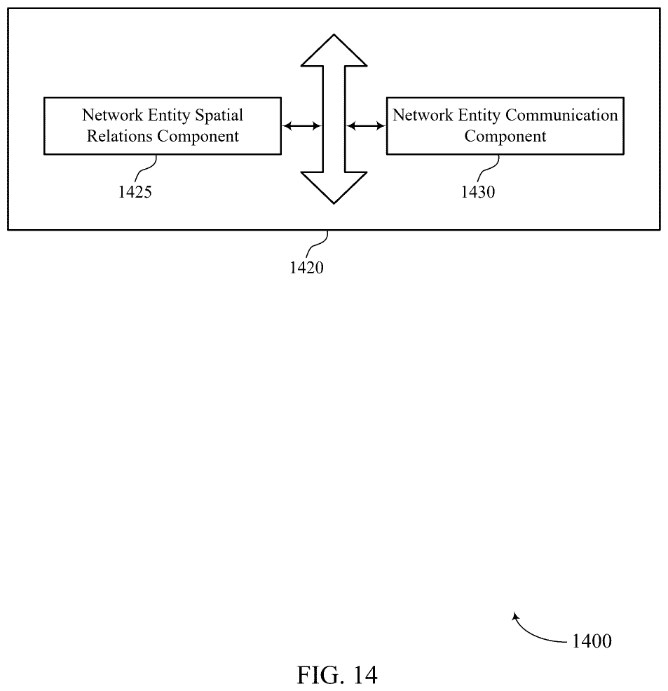

FIG. 14 shows a block diagram 1400 of a communications manager 1420 that supports techniques for the configuration and activation of spatial relations for uplink channel communications in accordance with one or more aspects of the present disclosure. The communications manager 1420 may be an example of aspects of a communications manager 1220, a communications manager 1320, or both, as described herein. The communications manager 1420, or various components thereof, may be an example of means for performing various aspects of techniques for the configuration and activation of spatial relations for uplink channel communications as described herein. For example, the communications manager 1420 may include a network entity spatial relations component 1425 a network entity communication component 1430, or any combination thereof. Each of these components, or components or subcomponents thereof (e.g., one or more processors, one or more memories), may communicate, directly or indirectly, with one another (e.g., via one or more buses). The communications may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

The communications manager 1420 may support wireless communications in accordance with examples as disclosed herein. The network entity spatial relations component 1425 is capable of, configured to, or operable to support a means for transmitting first information that configures one or more spatial relations for a PUCCH, an SRS, or an PUSCH resource. In some examples, the network entity spatial relations component 1425 is capable of, configured to, or operable to support a means for transmitting second information that activates the one or two respective spatial relations for sub-band full duplex (SBFD) symbols, non-SBFD symbols, or both. The network entity communication component 1430 is capable of, configured to, or operable to support a means for receiving an uplink communication that uses the PUCCH, SRS, or PUSCH resource in accordance with the activated one or two spatial relations for the SBFD symbols, the non-SBFD symbols, or both.

In some examples, the first information configures, for the PUCCH resource and on a per PUCCH resource basis, a first spatial relation of the one or more spatial relations. In some examples, the second information includes a first duplex type indicator that activates the first spatial relation for one of the SBFD symbols, the non-SBFD symbols, or both.

In some examples, the information includes a second duplex type indicator that indicates whether the PUCCH resource is restricted to a duplex type indicated by the first duplex type indicator or not.

In some examples, the first information configures, for the PUCCH resource and on a per PUCCH resource basis, a first spatial relation of the one or more spatial relations. In some examples, an absence of a first duplex type indicator in the second information indicates that the first spatial relation is activated for both the SBFD symbols and the non-SBFD symbols.

In some examples, the first information configures, for the PUCCH resource and on a per PUCCH resource basis, at least one of a first spatial relation of the one or more spatial relations and a second spatial relation of the one or more spatial relations. In some examples, the first spatial relation is associated with a first duplex type and the second spatial relation is associated with a second duplex type. In some examples, the first duplex type and the second duplex type are individually associated with the SBFD symbols, the non-SBFD symbols, or both.

In some examples, the second information includes both a first duplex type indicator that indicates that the first spatial relation is associated with the first duplex type and a second duplex type indicator that indicates that the second spatial relation is associated with the second duplex type.

In some examples, the second information includes a spatial relation quantity indicator that indicates that only the first spatial relation is configured and that the first spatial relation is associated with both the first duplex type and the second duplex type.

In some examples, the second information includes a spatial relation quantity indicator that indicates that both the first spatial relation and the second spatial relation are configured. In some examples, association of the first spatial relation with the first duplex type and of the second spatial relation with the second duplex type is based on an order of the first spatial relation and the second spatial relation in the second information.

In some examples, association of the first spatial relation with the first duplex type and of the second spatial relation with the second duplex type is based on an order of the first spatial relation and the second spatial relation in the second information.

In some examples, the second information includes a spatial relation quantity indicator that indicates that only the first spatial relation is configured. In some examples, the second information further includes a first duplex type indicator that indicates that the first spatial relation is associated with the first duplex type.

In some examples, the second information includes a first duplex type indicator that indicates that the first spatial relation is associated with both the first duplex type and the second duplex type. In some examples, indication that the first spatial relation is associated with both the first duplex type and the second duplex type is indicative that only the first spatial relation is configured.

In some examples, the second information includes a first duplex type indicator that indicates that the first spatial relation and the second spatial relation are associated with different duplex types. In some examples, the second information includes a second duplex type indicator that indicates that the first spatial relation is associated with the first duplex type and that the second spatial relation is associated with the second duplex type.

In some examples, the first information configures, for the SRS resource and on a per periodic SRS resource basis, a first spatial relation of the one or more spatial relations and a second spatial relation of the one or more spatial relations. In some examples, the first spatial relation is associated with a first duplex type and the second spatial relation is associated with a second duplex type. In some examples, association of the first spatial relation with the first duplex type and of the second spatial relation with the second duplex type is based on explicit indication in the first information or on an order of the first spatial relation and the second spatial relation in the first information. In some examples, the first duplex type and the second duplex type are individually associated with the SBFD symbols, the non-SBFD symbols, or both.

In some examples, the first information configures, for the SRS resource and on a per periodic SRS resource basis, a first spatial relation of the one or more spatial relations. In some examples, the first spatial relation is associated with both a first duplex type and a second duplex type or is associated, based on a duplex indicator restriction, with only one of the first duplex type or the second duplex type. In some examples, the first duplex type and the second duplex type are individually associated with the SBFD symbols, the non-SBFD symbols, or both.

In some examples, the first information configures, for a first SRS resource and on a per periodic SRS resource basis, a first spatial relation of the one or more spatial relations, and for a second SRS resource, a second spatial relation of the one or more spatial relations. In some examples, the SRS resource is one of the first SRS resource or the second SRS resource. In some examples, each of the first spatial relation and the second spatial relation is associated with a respective duplex type indicator that indicates an association with the SBFD symbols, the non-SBFD symbols, or both.

In some examples, the first information configures, for the SRS resource and on a per semi-persistent SRS resource basis, a first spatial relation of the one or more spatial relations. In some examples, the second information includes a first duplex type indicator that activates the first spatial relation for one of the SBFD symbols, the non-SBFD symbols, or both.

In some examples, the second information includes a second duplex type indicator that indicates whether the SRS resource is restricted to a duplex type indicated by the first duplex type indicator or not.

In some examples, the first information configures, for the SRS resource and on a per semi-persistent SRS resource basis, a first spatial relation of the one or more spatial relations. In some examples, an absence of a first duplex type indicator in the second information indicates that the first spatial relation is activated for both the SBFD symbols and the non-SBFD symbols.

In some examples, the first information configures, for the SRS resource and on a per semi-persistent SRS resource basis, at least one of a first spatial relation of the one or more spatial relations and a second spatial relation of the one or more spatial relations. In some examples, the first spatial relation is associated with a first duplex type and the second spatial relation is associated with a second duplex type. In some examples, the first duplex type and the second duplex type are individually associated with the SBFD symbols, the non-SBFD symbols, or both.

In some examples, the second information includes both a first duplex type indicator that indicates that the first spatial relation is associated with the first duplex type and a second duplex type indicator that indicates that the second spatial relation is associated with the second duplex type.

In some examples, the second information includes a spatial relation quantity indicator that indicates that only the first spatial relation is configured and that the first spatial relation is associated with both the first duplex type and the second duplex type.

In some examples, the second information includes a spatial relation quantity indicator that indicates that both the first spatial relation and the second spatial relation are configured. In some examples, association of the first spatial relation with the first duplex type and of the second spatial relation with the second duplex type is based on an order of the first spatial relation and the second spatial relation in the second information.

In some examples, association of the first spatial relation with the first duplex type and of the second spatial relation with the second duplex type is based on an order of the first spatial relation and the second spatial relation in the second information.

In some examples, the second information includes a spatial relation quantity indicator that indicates that only the first spatial relation is configured. In some examples, the second information further includes a first duplex type indicator that indicates that the first spatial relation is associated with the first duplex type.

In some examples, the second information includes a first duplex type indicator that indicates that the first spatial relation is associated with both the first duplex type and the second duplex type. In some examples, indication that the first spatial relation is associated with both the first duplex type and the second duplex type is indicative that only the first spatial relation is configured.

In some examples, the second information includes a first duplex type indicator that indicates that the first spatial relation and the second spatial relation are associated with different duplex types. In some examples, the second information includes a second duplex type indicator that indicates that the first spatial relation is associated with the first duplex type and that the second spatial relation is associated with the second duplex type.

In some examples, the first information configures, for the SRS resource, at least one of a first spatial relation of the one or more spatial relations and a second spatial relation of the one or more spatial relations. In some examples, the SRS resource is an aperiodically triggered SRS resource. In some examples, each of the first spatial relation and the second spatial relation is associated with a respective duplex type that indicates an association with the SBFD symbols, the non-SBFD symbols, or both. In some examples, the uplink communication is received in accordance with the first spatial relation or the second spatial relation based on a target slot type of the aperiodically triggered SRS resource.

In some examples, the first information configures, for the SRS resource, a first spatial relation of the one or more spatial relations and a second spatial relation of the one or more spatial relations. In some examples, the SRS resource is an aperiodically triggered SRS resource. In some examples, each of the first spatial relation and the second spatial relation is associated with a respective duplex type that indicates an association with the SBFD symbols, the non-SBFD symbols, or both. In some examples, the uplink communication is received in accordance with the first spatial relation or the second spatial relation based on a duplex type indicator field included in the second information.

In some examples, the first information configures, for the SRS resource, a first spatial relation of the one or more spatial relations and a second spatial relation of the one or more spatial relations. In some examples, the SRS resource is an aperiodically triggered SRS resource. In some examples, each of the first spatial relation and the second spatial relation is associated with a respective duplex type that indicates an association with the SBFD symbols, the non-SBFD symbols, or both. In some examples, the uplink communication is received in accordance with the first spatial relation or the second spatial relation based on a symbol type associated with the aperiodically triggered SRS resource.

In some examples, the second information includes a downlink control information which indicates, for the PUSCH resource, a first SRS resource indicator (SRI) that includes at least a first spatial relation of the one or more spatial relations. In some examples, the first spatial relation is associated with a first duplex type via a duplex type indicator. In some examples, the PUSCH resource is a Type 2 configured grant or a dynamic grant PUSCH resource and. In some examples, the first duplex type is individually associated with the SBFD symbols, the non-SBFD symbols, or both.

In some examples, the second information includes a downlink control information which indicates, for the PUSCH resource, a first SRS resource indicator (SRI) that includes a first spatial relation of the one or more spatial relations. In some examples, the first spatial relation is associated with either a first duplex type or both the first duplex type and a second duplex type. In some examples, the PUSCH resource is a Type 2 configured grant or a dynamic grant PUSCH resource and. In some examples, the first duplex type and the second duplex type are individually associated with the SBFD symbols, the non-SBFD symbols, or both.

In some examples, the second information includes a downlink control information which indicates, for the PUSCH resource, a first SRS resource indicator (SRI) that includes a first spatial relation of the one or more spatial relations and a second SRI that includes a second spatial relation of the one or more spatial relations. In some examples, the first spatial relation is associated with a first duplex type and the second spatial relation is associated with a second duplex type. In some examples, the PUSCH resource is a Type 2 configured grant or a dynamic grant PUSCH resource and. In some examples, the first duplex type and the second duplex type are individually associated with the SBFD symbols, the non-SBFD symbols, or both.

In some examples, the first information configures, for the PUSCH resource and on a per PUSCH resource basis, at least one of a first SRS resource indicator (SRI) and a second SRI, each of the first SRI and the second SRI indicating the one or more spatial relations associated with a duplex type of the SRS resource. In some examples, the PUSCH resource is a Type 1 configured grant.

In some examples, the first information configures an SRS resource indicator for the PUSCH resource on a per PUSCH resource basis. In some examples, the SRI indicates that the SRS resource is configured with a first spatial relation of the one or more spatial relations and a second SRI that includes a second spatial relation of the one or more spatial relations for both the SBFD symbols and the non-SBFD symbols. In some examples, the PUSCH resource is a Type 1 configured grant.

In some examples, the first information configures an SRS resource indicator for the PUSCH resource on a per PUSCH resource basis. In some examples, the SRI indicates that the SRS resource is configured with a first spatial relation of the one or more spatial relations associated with a duplex type based on a duplex indicator restriction.

In some examples, the first information configures, for the PUSCH resource and on a per PUSCH resource basis, a first spatial relation of the one or more spatial relations and a second spatial relation of the one or more spatial relations. In some examples, the second information activates the first spatial relation for the PUSCH resource. In some examples, the first spatial relation is associated with a first duplex type via a duplex type indicator, the first duplex type being individually associated with the SBFD symbols, the non-SBFD symbols, or both. In some examples, the PUSCH resource is a Type 1 configured grant.

In some examples, the first information configures, for the PUSCH resource and on a per PUSCH resource basis, a first spatial relation of the one or more spatial relations and a second spatial relation of the one or more spatial relations. In some examples, the second information activates the first spatial relation and the second spatial relation for the PUSCH resource. In some examples, the first spatial relation is associated with a first duplex type and the second spatial relation is associated with a second duplex type. In some examples, the first duplex type and the second duplex type are individually associated with the SBFD symbols, the non-SBFD symbols, or both. In some examples, the PUSCH resource is a Type 1 configured grant.

In some examples, the first information includes a radio resource control message. In some examples, the second information includes a medium access control control element or a downlink control information.

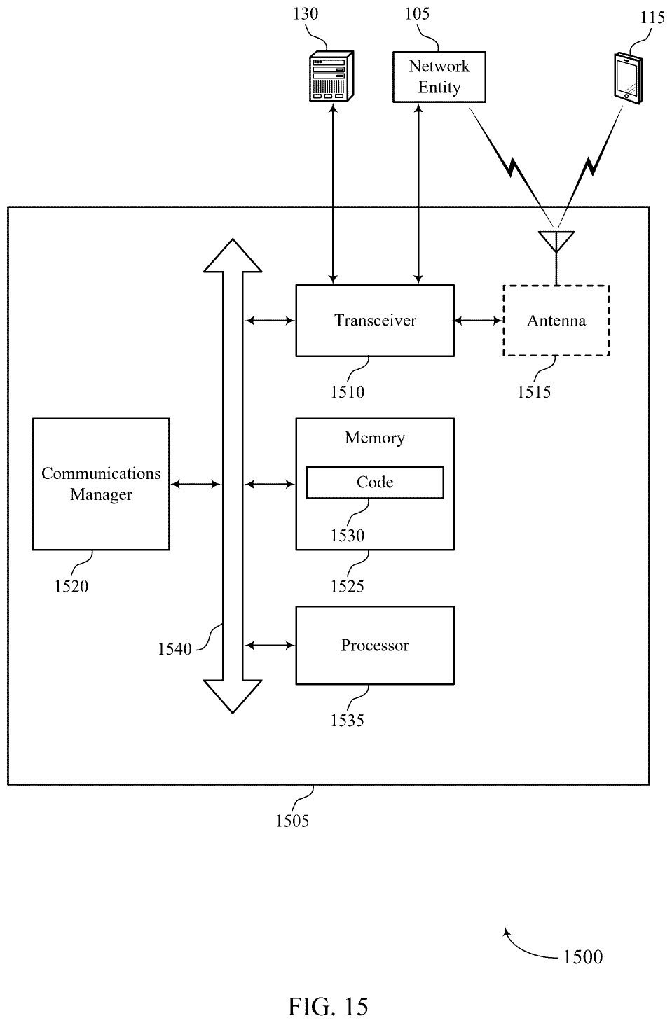

FIG. 15 shows a diagram of a system 1500 including a device 1505 that supports techniques for the configuration and activation of spatial relations for uplink channel communications in accordance with one or more aspects of the present disclosure. The device 1505 may be an example of or include components of a device 1205, a device 1305, or a network entity 105 as described herein. The device 1505 may communicate with other network devices or network equipment such as one or more of the network entities 105, UEs 115, or any combination thereof. The communications may include communications over one or more wired interfaces, over one or more wireless interfaces, or any combination thereof. The device 1505 may include components that support outputting and obtaining communications, such as a communications manager 1520, a transceiver 1510, one or more antennas 1515, at least one memory 1525, code 1530, and at least one processor 1535. These components may be in electronic communication or otherwise coupled (e.g., operatively, communicatively, functionally, electronically, electrically) via one or more buses (e.g., a bus 1540).

The transceiver 1510 may support bi-directional communications via wired links, wireless links, or both as described herein. In some examples, the transceiver 1510 may include a wired transceiver and may communicate bi-directionally with another wired transceiver. Additionally, or alternatively, in some examples, the transceiver 1510 may include a wireless transceiver and may communicate bi-directionally with another wireless transceiver. In some examples, the device 1505 may include one or more antennas 1515, which may be capable of transmitting or receiving wireless transmissions (e.g., concurrently). The transceiver 1510 may also include a modem to modulate signals, to provide the modulated signals for transmission (e.g., by one or more antennas 1515, by a wired transmitter), to receive modulated signals (e.g., from one or more antennas 1515, from a wired receiver), and to demodulate signals. In some implementations, the transceiver 1510 may include one or more interfaces, such as one or more interfaces coupled with the one or more antennas 1515 that are configured to support various receiving or obtaining operations, or one or more interfaces coupled with the one or more antennas 1515 that are configured to support various transmitting or outputting operations, or a combination thereof. In some implementations, the transceiver 1510 may include or be configured for coupling with one or more processors or one or more memory components that are operable to perform or support operations based on received or obtained information or signals, or to generate information or other signals for transmission or other outputting, or any combination thereof. In some implementations, the transceiver 1510, or the transceiver 1510 and the one or more antennas 1515, or the transceiver 1510 and the one or more antennas 1515 and one or more processors or one or more memory components (e.g., the at least one processor 1535, the at least one memory 1525, or both), may be included in a chip or chip assembly that is installed in the device 1505. In some examples, the transceiver 1510 may be operable to support communications via one or more communications links (e.g., communication link(s) 125, backhaul communication link(s) 120, a midhaul communication link 162, a fronthaul communication link 168).

The at least one memory 1525 may include RAM, ROM, or any combination thereof. The at least one memory 1525 may store computer-readable, computer-executable, or processor-executable code, such as the code 1530. The code 1530 may include instructions that, when executed by one or more of the at least one processor 1535, cause the device 1505 to perform various functions described herein. The code 1530 may be stored in a non-transitory computer-readable medium such as system memory or another type of memory. In some cases, the code 1530 may not be directly executable by a processor of the at least one processor 1535 but may cause a computer (e.g., when compiled and executed) to perform functions described herein. In some cases, the at least one memory 1525 may include, among other things, a BIOS which may control basic hardware or software operation such as the interaction with peripheral components or devices. In some examples, the at least one processor 1535 may include multiple processors and the at least one memory 1525 may include multiple memories. One or more of the multiple processors may be coupled with one or more of the multiple memories which may, individually or collectively, be configured to perform various functions herein (for example, as part of a processing system).

The at least one processor 1535 may include one or more intelligent hardware devices (e.g., one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 1535 may be configured to operate a memory array using a memory controller. In some other cases, a memory controller may be integrated into one or more of the at least one processor 1535. The at least one processor 1535 may be configured to execute computer-readable instructions stored in a memory (e.g., one or more of the at least one memory 1525) to cause the device 1505 to perform various functions (e.g., functions or tasks supporting techniques for the configuration and activation of spatial relations for uplink channel communications). For example, the device 1505 or a component of the device 1505 may include at least one processor 1535 and at least one memory 1525 coupled with one or more of the at least one processor 1535, the at least one processor 1535 and the at least one memory 1525 configured to perform various functions described herein. The at least one processor 1535 may be an example of a cloud-computing platform (e.g., one or more physical nodes and supporting software such as operating systems, virtual machines, or container instances) that may host the functions (e.g., by executing code 1530) to perform the functions of the device 1505. The at least one processor 1535 may be any one or more suitable processors capable of executing scripts or instructions of one or more software programs stored in the device 1505 (such as within one or more of the at least one memory 1525).

In some examples, the at least one processor 1535 may include multiple processors and the at least one memory 1525 may include multiple memories. One or more of the multiple processors may be coupled with one or more of the multiple memories, which may, individually or collectively, be configured to perform various functions herein. In some examples, the at least one processor 1535 may be a component of a processing system, which may refer to a system (such as a series) of machines, circuitry (including, for example, one or both of processor circuitry (which may include the at least one processor 1535) and memory circuitry (which may include the at least one memory 1525)), or components, that receives or obtains inputs and processes the inputs to produce, generate, or obtain a set of outputs. The processing system may be configured to perform one or more of the functions described herein. For example, the at least one processor 1535 or a processing system including the at least one processor 1535 may be configured to, configurable to, or operable to cause the device 1505 to perform one or more of the functions described herein. Further, as described herein, being “configured to,” being “configurable to,” and being “operable to” may be used interchangeably and may be associated with a capability, when executing code stored in the at least one memory 1525 or otherwise, to perform one or more of the functions described herein.

In some examples, a bus 1540 may support communications of (e.g., within) a protocol layer of a protocol stack. In some examples, a bus 1540 may support communications associated with a logical channel of a protocol stack (e.g., between protocol layers of a protocol stack), which may include communications performed within a component of the device 1505, or between different components of the device 1505 that may be co-located or located in different locations (e.g., where the device 1505 may refer to a system in which one or more of the communications manager 1520, the transceiver 1510, the at least one memory 1525, the code 1530, and the at least one processor 1535 may be located in one of the different components or divided between different components).

In some examples, the communications manager 1520 may manage aspects of communications with a core network 130 (e.g., via one or more wired or wireless backhaul links). For example, the communications manager 1520 may manage the transfer of data communications for client devices, such as one or more UEs 115. In some examples, the communications manager 1520 may manage communications with one or more other network entities 105, and may include a controller or scheduler for controlling communications with UEs 115 (e.g., in cooperation with the one or more other network devices). In some examples, the communications manager 1520 may support an X2 interface within an LTE/LTE-A wireless communications network technology to provide communication between network entities 105.

The communications manager 1520 may support wireless communications in accordance with examples as disclosed herein. For example, the communications manager 1520 is capable of, configured to, or operable to support a means for transmitting first information that configures one or more spatial relations for a PUCCH, an SRS, or an PUSCH resource. The communications manager 1520 is capable of, configured to, or operable to support a means for transmitting second information that activates the one or two respective spatial relations for sub-band full duplex (SBFD) symbols, non-SBFD symbols, or both. The communications manager 1520 is capable of, configured to, or operable to support a means for receiving an uplink communication that uses the PUCCH, SRS, or PUSCH resource in accordance with the activated one or two spatial relations for the SBFD symbols, the non-SBFD symbols, or both.

By including or configuring the communications manager 1520 in accordance with examples as described herein, the device 1505 may support techniques for the configuration and activation of spatial relations for uplink channel communications resulting in reduced interference and enhanced signal gains.

In some examples, the communications manager 1520 may be configured to perform various operations (e.g., receiving, obtaining, monitoring, outputting, transmitting) using or otherwise in cooperation with the transceiver 1510, the one or more antennas 1515 (e.g., where applicable), or any combination thereof. Although the communications manager 1520 is illustrated as a separate component, in some examples, one or more functions described with reference to the communications manager 1520 may be supported by or performed by the transceiver 1510, one or more of the at least one processor 1535, one or more of the at least one memory 1525, the code 1530, or any combination thereof (for example, by a processing system including at least a portion of the at least one processor 1535, the at least one memory 1525, the code 1530, or any combination thereof). For example, the code 1530 may include instructions executable by one or more of the at least one processor 1535 to cause the device 1505 to perform various aspects of techniques for the configuration and activation of spatial relations for uplink channel communications as described herein, or the at least one processor 1535 and the at least one memory 1525 may be otherwise configured to, individually or collectively, perform or support such operations.

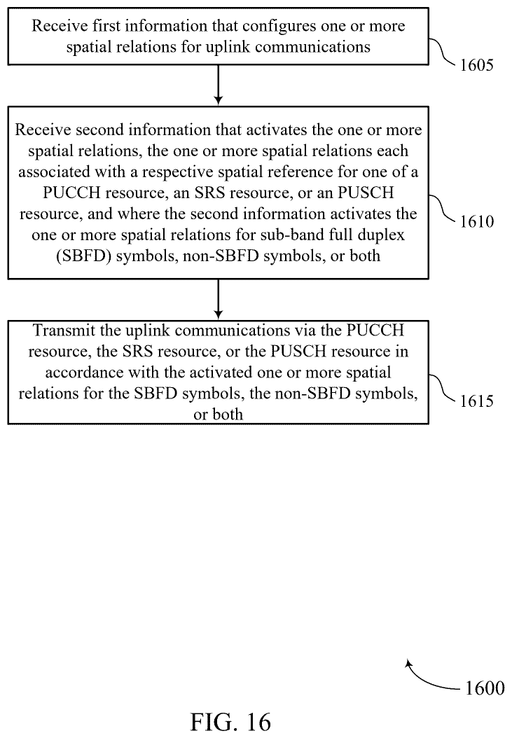

FIG. 16 shows a flowchart illustrating a method 1600 that supports techniques for the configuration and activation of spatial relations for uplink channel communications in accordance with one or more aspects of the present disclosure. The operations of the method 1600 may be implemented by a UE or its components as described herein. For example, the operations of the method 1600 may be performed by a UE 115 as described with reference to FIGS. 1 through 11. In some examples, a UE may execute a set of instructions to control the functional elements of the UE to perform the described functions. Additionally, or alternatively, the UE may perform aspects of the described functions using special-purpose hardware.

At 1605, the method may include receiving first information that configures one or more spatial relations for uplink communications. The operations of 1605 may be performed in accordance with examples as disclosed herein. In some examples, aspects of the operations of 1605 may be performed by a UE spatial relations component 1025 as described with reference to FIG. 10.

At 1610, the method may include receiving second information that activates the one or more spatial relations, the one or more spatial relations each associated with a respective spatial reference for one of a PUCCH resource, an SRS resource, or an PUSCH resource, and where the second information activates the one or more spatial relations for sub-band full duplex (SBFD) symbols, non-SBFD symbols, or both. The operations of 1610 may be performed in accordance with examples as disclosed herein. In some examples, aspects of the operations of 1610 may be performed by a UE spatial relations component 1025 as described with reference to FIG. 10.

At 1615, the method may include transmitting the uplink communications via the PUCCH resource, the SRS resource, or the PUSCH resource in accordance with the activated one or more spatial relations for the SBFD symbols, the non-SBFD symbols, or both. The operations of 1615 may be performed in accordance with examples as disclosed herein. In some examples, aspects of the operations of 1615 may be performed by a UE communication component 1030 as described with reference to FIG. 10.

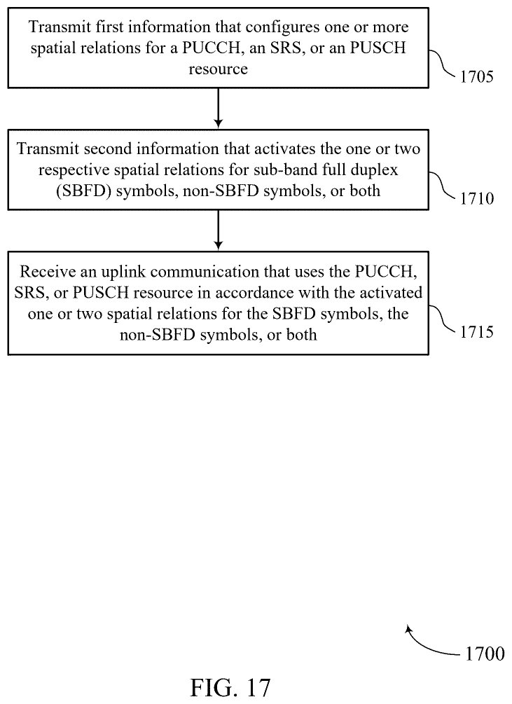

FIG. 17 shows a flowchart illustrating a method 1700 that supports techniques for the configuration and activation of spatial relations for uplink channel communications in accordance with one or more aspects of the present disclosure. The operations of the method 1700 may be implemented by a network entity or its components as described herein. For example, the operations of the method 1700 may be performed by a network entity as described with reference to FIGS. 1 through 7 and 12 through 15. In some examples, a network entity may execute a set of instructions to control the functional elements of the network entity to perform the described functions. Additionally, or alternatively, the network entity may perform aspects of the described functions using special-purpose hardware.

At 1705, the method may include transmitting first information that configures one or more spatial relations for a PUCCH, an SRS, or an PUSCH resource. The operations of 1705 may be performed in accordance with examples as disclosed herein. In some examples, aspects of the operations of 1705 may be performed by a network entity spatial relations component 1425 as described with reference to FIG. 14.

At 1710, the method may include transmitting second information that activates the one or two respective spatial relations for sub-band full duplex (SBFD) symbols, non-SBFD symbols, or both. The operations of 1710 may be performed in accordance with examples as disclosed herein. In some examples, aspects of the operations of 1710 may be performed by a network entity spatial relations component 1425 as described with reference to FIG. 14.

At 1715, the method may include receiving an uplink communication that uses the PUCCH, SRS, or PUSCH resource in accordance with the activated one or two spatial relations for the SBFD symbols, the non-SBFD symbols, or both. The operations of 1715 may be performed in accordance with examples as disclosed herein. In some examples, aspects of the operations of 1715 may be performed by a network entity communication component 1430 as described with reference to FIG. 14.

The following provides an overview of aspects of the present disclosure:

Aspect 1: A method for wireless communications at a user equipment, comprising: receiving first information that configures one or more spatial relations for uplink communications; receiving second information that activates the one or more spatial relations, the one or more spatial relations each associated with a respective spatial reference for one of a PUCCH resource, an SRS resource, or an PUSCH resource, and wherein the second information activates the one or more spatial relations for sub-band full duplex (SBFD) symbols, non-SBFD symbols, or both; and transmitting the uplink communications via the PUCCH resource, the SRS resource, or the PUSCH resource in accordance with the activated one or more spatial relations for the SBFD symbols, the non-SBFD symbols, or both.

Aspect 2: The method of aspect 1, wherein the first information configures, for the PUCCH resource and on a per PUCCH resource basis, a first spatial relation of the one or more spatial relations, the second information includes a first duplex type indicator that activates the first spatial relation for one of the SBFD symbols, the non-SBFD symbols, or both.

Aspect 3: The method of aspect 2, wherein the second information includes a second duplex type indicator that indicates whether the PUCCH resource is restricted to a duplex type indicated by the first duplex type indicator or not.

Aspect 4: The method of any of aspects 1 through 3, wherein the first information configures, for the PUCCH resource and on a per PUCCH resource basis, a first spatial relation of the one or more spatial relations, an absence of a first duplex type indicator in the second information indicates that the first spatial relation is activated for both the SBFD symbols and the non-SBFD symbols.

Aspect 5: The method of any of aspects 1 through 4, wherein the first information configures, for the PUCCH resource and on a per PUCCH resource basis, at least one of a first spatial relation of the one or more spatial relations and a second spatial relation of the one or more spatial relations, the first spatial relation is associated with a first duplex type and the second spatial relation is associated with a second duplex type, the first duplex type and the second duplex type are individually associated with the SBFD symbols, the non-SBFD symbols, or both.

Aspect 6: The method of aspect 5, wherein the second information includes both a first duplex type indicator that indicates that the first spatial relation is associated with the first duplex type and a second duplex type indicator that indicates that the second spatial relation is associated with the second duplex type.

Aspect 7: The method of any of aspects 5 through 6, wherein the second information includes a spatial relation quantity indicator that indicates that only the first spatial relation is configured and that the first spatial relation is associated with both the first duplex type and the second duplex type.

Aspect 8: The method of any of aspects 5 through 7, wherein the second information includes a spatial relation quantity indicator that indicates that both the first spatial relation and the second spatial relation are configured, and association of the first spatial relation with the first duplex type and of the second spatial relation with the second duplex type is based on an order of the first spatial relation and the second spatial relation in the second information.

Aspect 9: The method of any of aspects 5 through 8, wherein association of the first spatial relation with the first duplex type and of the second spatial relation with the second duplex type is based on an order of the first spatial relation and the second spatial relation in the second information.

Aspect 10: The method of any of aspects 5 through 9, wherein the second information includes a spatial relation quantity indicator that indicates that only the first spatial relation is configured, the second information further includes a first duplex type indicator that indicates that the first spatial relation is associated with the first duplex type.

Aspect 11: The method of any of aspects 5 through 10, wherein the second information includes a first duplex type indicator that indicates that the first spatial relation is associated with both the first duplex type and the second duplex type, and indication that the first spatial relation is associated with both the first duplex type and the second duplex type is indicative that only the first spatial relation is configured.

Aspect 12: The method of any of aspects 5 through 11, wherein the second information includes a first duplex type indicator that indicates that the first spatial relation and the second spatial relation are associated with different duplex types, and the second information includes a second duplex type indicator that indicates that the first spatial relation is associated with the first duplex type and that the second spatial relation is associated with the second duplex type.

Aspect 13: The method of any of aspects 1 through 12, wherein the first information configures, for the SRS resource and on a per periodic SRS resource basis, a first spatial relation of the one or more spatial relations and a second spatial relation of the one or more spatial relations, the first spatial relation is associated with a first duplex type and the second spatial relation is associated with a second duplex type, association of the first spatial relation with the first duplex type and of the second spatial relation with the second duplex type is based on explicit indication in the first information or on an order of the first spatial relation and the second spatial relation in the first information, the first duplex type and the second duplex type are individually associated with the SBFD symbols, the non-SBFD symbols, or both.

Aspect 14: The method of any of aspects 1 through 13, wherein the first information configures, for the SRS resource and on a per periodic SRS resource basis, a first spatial relation of the one or more spatial relations, the first spatial relation is associated with both a first duplex type and a second duplex type or is associated, based on a duplex indicator restriction, with only one of the first duplex type or the second duplex type, the first duplex type and the second duplex type are individually associated with the SBFD symbols, the non-SBFD symbols, or both.

Aspect 15: The method of any of aspects 1 through 14, wherein the first information configures, for a first SRS resource and on a per periodic SRS resource basis, a first spatial relation of the one or more spatial relations, and for a second SRS resource, a second spatial relation of the one or more spatial relations, the SRS resource is one of the first SRS resource or the second SRS resource, and each of the first spatial relation and the second spatial relation is associated with a respective duplex type indicator that indicates an association with the SBFD symbols, the non-SBFD symbols, or both.

Aspect 16: The method of any of aspects 1 through 15, wherein the first information configures, for the SRS resource and on a per semi-persistent SRS resource basis, a first spatial relation of the one or more spatial relations, the second information includes a first duplex type indicator that activates the first spatial relation for one of the SBFD symbols, the non-SBFD symbols, or both.

Aspect 17: The method of aspect 16, wherein the second information includes a second duplex type indicator that indicates whether the SRS resource is restricted to a duplex type indicated by the first duplex type indicator or not.

Aspect 18: The method of any of aspects 1 through 17, wherein the first information configures, for the SRS resource and on a per semi-persistent SRS resource basis, a first spatial relation of the one or more spatial relations, an absence of a first duplex type indicator in the second information indicates that the first spatial relation is activated for both the SBFD symbols and the non-SBFD symbols.

Aspect 19: The method of any of aspects 1 through 18, wherein the first information configures, for the SRS resource and on a per semi-persistent SRS resource basis, at least one of a first spatial relation of the one or more spatial relations and a second spatial relation of the one or more spatial relations, and the first spatial relation is associated with a first duplex type and the second spatial relation is associated with a second duplex type, the first duplex type and the second duplex type are individually associated with the SBFD symbols, the non-SBFD symbols, or both.

Aspect 20: The method of aspect 19, wherein the second information includes both a first duplex type indicator that indicates that the first spatial relation is associated with the first duplex type and a second duplex type indicator that indicates that the second spatial relation is associated with the second duplex type.

Aspect 21: The method of any of aspects 19 through 20, wherein the second information includes a spatial relation quantity indicator that indicates that only the first spatial relation is configured and that the first spatial relation is associated with both the first duplex type and the second duplex type.

Aspect 22: The method of any of aspects 19 through 21, wherein the second information includes a spatial relation quantity indicator that indicates that both the first spatial relation and the second spatial relation are configured, and association of the first spatial relation with the first duplex type and of the second spatial relation with the second duplex type is based on an order of the first spatial relation and the second spatial relation in the second information.

Aspect 23: The method of any of aspects 19 through 22, wherein association of the first spatial relation with the first duplex type and of the second spatial relation with the second duplex type is based on an order of the first spatial relation and the second spatial relation in the second information.

Aspect 24: The method of any of aspects 19 through 23, wherein the second information includes a spatial relation quantity indicator that indicates that only the first spatial relation is configured, the second information further includes a first duplex type indicator that indicates that the first spatial relation is associated with the first duplex type.

Aspect 25: The method of any of aspects 19 through 24, wherein the second information includes a first duplex type indicator that indicates that the first spatial relation is associated with both the first duplex type and the second duplex type, and indication that the first spatial relation is associated with both the first duplex type and the second duplex type is indicative that only the first spatial relation is configured.

Aspect 26: The method of any of aspects 19 through 25, wherein the second information includes a first duplex type indicator that indicates that the first spatial relation and the second spatial relation are associated with different duplex types, and the second information includes a second duplex type indicator that indicates that the first spatial relation is associated with the first duplex type and that the second spatial relation is associated with the second duplex type.

Aspect 27: The method of any of aspects 1 through 26, wherein the first information configures, for the SRS resource, at least one of a first spatial relation of the one or more spatial relations and a second spatial relation of the one or more spatial relations, wherein the SRS resource is an aperiodically triggered SRS resource, and wherein each of the first spatial relation and the second spatial relation is associated with a respective duplex type that indicates an association with the SBFD symbols, the non-SBFD symbols, or both, the method further comprising: selecting one of the first spatial relation or the second spatial relation for application with the aperiodically triggered SRS resource, wherein the selection is based at least in part on a target slot type of the aperiodically triggered SRS resource.

Aspect 28: The method of any of aspects 1 through 27, wherein the first information configures, for the SRS resource, a first spatial relation of the one or more spatial relations and a second spatial relation of the one or more spatial relations, wherein the SRS resource is an aperiodically triggered SRS resource, and wherein each of the first spatial relation and the second spatial relation is associated with a respective duplex type that indicates an association with the SBFD symbols, the non-SBFD symbols, or both, the method further comprising: selecting one of the first spatial relation or the second spatial relation for application with the aperiodically triggered SRS resource, wherein the selection is based at least in part on a duplex type indicator field included in the second information.

Aspect 29: The method of any of aspects 1 through 28, wherein the first information configures, for the SRS resource, a first spatial relation of the one or more spatial relations and a second spatial relation of the one or more spatial relations, wherein the SRS resource is an aperiodically triggered SRS resource, and wherein each of the first spatial relation and the second spatial relation is associated with a respective duplex type that indicates an association with the SBFD symbols, the non-SBFD symbols, or both, the method further comprising: selecting one of the first spatial relation or the second spatial relation for application with the aperiodically triggered SRS resource, wherein the selection is based at least in part on a symbol type associated with the aperiodically triggered SRS resource.

Aspect 30: The method of any of aspects 1 through 29, wherein the second information comprises a downlink control information which indicates, for the PUSCH resource, a first SRS resource indicator (SRI) that includes at least a first spatial relation of the one or more spatial relations, the first spatial relation is associated with a first duplex type via a duplex type indicator, the PUSCH resource is a Type 2 configured grant or a dynamic grant PUSCH resource and the first duplex type is individually associated with the SBFD symbols, the non-SBFD symbols, or both.

Aspect 31: The method of any of aspects 1 through 30, wherein the second information comprises a downlink control information which indicates, for the PUSCH resource, a first SRS resource indicator (SRI) that includes a first spatial relation of the one or more spatial relations, the first spatial relation is associated with either a first duplex type or both the first duplex type and a second duplex type, the PUSCH resource is a Type 2 configured grant or a dynamic grant PUSCH resource and the first duplex type and the second duplex type are individually associated with the SBFD symbols, the non-SBFD symbols, or both.

Aspect 32: The method of any of aspects 1 through 31, wherein the second information comprises a downlink control information which indicates, for the PUSCH resource, a first SRS resource indicator (SRI) that includes a first spatial relation of the one or more spatial relations and a second SRI that includes a second spatial relation of the one or more spatial relations, the first spatial relation is associated with a first duplex type and the second spatial relation is associated with a second duplex type, the PUSCH resource is a Type 2 configured grant or a dynamic grant PUSCH resource, and the first duplex type and the second duplex type are individually associated with the SBFD symbols, the non-SBFD symbols, or both.

Aspect 33: The method of any of aspects 1 through 32, wherein the first information configures, for the PUSCH resource and on a per PUSCH resource basis, at least one of a first SRS resource indicator (SRI) and a second SRI, each of the first SRI and the second SRI indicating the one or more spatial relations associated with a duplex type of the SRS resource, the PUSCH resource is a Type 1 configured grant.

Aspect 34: The method of any of aspects 1 through 33, wherein the first information configures an SRS resource indicator for the PUSCH resource on a per PUSCH resource basis, the SRI indicates that the SRS resource is configured with a first spatial relation of the one or more spatial relations and a second SRI that includes a second spatial relation of the one or more spatial relations for both the SBFD symbols and the non-SBFD symbols, the PUSCH resource is a Type 1 configured grant.

Aspect 35: The method of any of aspects 1 through 34, wherein the first information configures an SRS resource indicator for the PUSCH resource on a per PUSCH resource basis, the SRI indicates that the SRS resource is configured with a first spatial relation of the one or more spatial relations associated with a duplex type based at least in part on a duplex indicator restriction.

Aspect 36: The method of any of aspects 1 through 35, wherein the first information configures, for the PUSCH resource and on a per PUSCH resource basis, a first spatial relation of the one or more spatial relations and a second spatial relation of the one or more spatial relations, the second information activates the first spatial relation for the PUSCH resource, and the first spatial relation is associated with a first duplex type via a duplex type indicator, the first duplex type being individually associated with the SBFD symbols, the non-SBFD symbols, or both the PUSCH resource is a Type 1 configured grant.

Aspect 37: The method of any of aspects 1 through 36, wherein the first information configures, for the PUSCH resource and on a per PUSCH resource basis, a first spatial relation of the one or more spatial relations and a second spatial relation of the one or more spatial relations, the second information activates the first spatial relation and the second spatial relation for the PUSCH resource, the first spatial relation is associated with a first duplex type and the second spatial relation is associated with a second duplex type, and the first duplex type and the second duplex type are individually associated with the SBFD symbols, the non-SBFD symbols, or both the PUSCH resource is a Type 1 configured grant.

Aspect 38: The method of any of aspects 1 through 37, wherein the first information comprises a radio resource control message, and the second information comprises a medium access control control element or a downlink control information.

Aspect 39: A method for wireless communications at a network entity, comprising: transmitting first information that configures one or more spatial relations for a PUCCH, an SRS, or an PUSCH resource; transmitting second information that activates the one or two respective spatial relations for sub-band full duplex (SBFD) symbols, non-SBFD symbols, or both; and receiving an uplink communication that uses the PUCCH, SRS, or PUSCH resource in accordance with the activated one or two spatial relations for the SBFD symbols, the non-SBFD symbols, or both.

Aspect 40: The method of aspect 39, wherein the first information configures, for the PUCCH resource and on a per PUCCH resource basis, a first spatial relation of the one or more spatial relations, the second information includes a first duplex type indicator that activates the first spatial relation for one of the SBFD symbols, the non-SBFD symbols, or both.

Aspect 41: The method of aspect 40, wherein the information includes a second duplex type indicator that indicates whether the PUCCH resource is restricted to a duplex type indicated by the first duplex type indicator or not.

Aspect 42: The method of any of aspects 39 through 41, wherein the first information configures, for the PUCCH resource and on a per PUCCH resource basis, a first spatial relation of the one or more spatial relations, an absence of a first duplex type indicator in the second information indicates that the first spatial relation is activated for both the SBFD symbols and the non-SBFD symbols.

Aspect 43: The method of any of aspects 39 through 42, wherein the first information configures, for the PUCCH resource and on a per PUCCH resource basis, at least one of a first spatial relation of the one or more spatial relations and a second spatial relation of the one or more spatial relations, the first spatial relation is associated with a first duplex type and the second spatial relation is associated with a second duplex type, the first duplex type and the second duplex type are individually associated with the SBFD symbols, the non-SBFD symbols, or both.

Aspect 44: The method of aspect 43, wherein the second information includes both a first duplex type indicator that indicates that the first spatial relation is associated with the first duplex type and a second duplex type indicator that indicates that the second spatial relation is associated with the second duplex type.

Aspect 45: The method of any of aspects 43 through 44, wherein the second information includes a spatial relation quantity indicator that indicates that only the first spatial relation is configured and that the first spatial relation is associated with both the first duplex type and the second duplex type.

Aspect 46: The method of any of aspects 43 through 45, wherein the second information includes a spatial relation quantity indicator that indicates that both the first spatial relation and the second spatial relation are configured, and association of the first spatial relation with the first duplex type and of the second spatial relation with the second duplex type is based on an order of the first spatial relation and the second spatial relation in the second information.

Aspect 47: The method of any of aspects 43 through 46, wherein association of the first spatial relation with the first duplex type and of the second spatial relation with the second duplex type is based on an order of the first spatial relation and the second spatial relation in the second information.

Aspect 48: The method of any of aspects 43 through 47, wherein the second information includes a spatial relation quantity indicator that indicates that only the first spatial relation is configured, the second information further includes a first duplex type indicator that indicates that the first spatial relation is associated with the first duplex type.

Aspect 49: The method of any of aspects 43 through 48, wherein the second information includes a first duplex type indicator that indicates that the first spatial relation is associated with both the first duplex type and the second duplex type, and indication that the first spatial relation is associated with both the first duplex type and the second duplex type is indicative that only the first spatial relation is configured.

Aspect 50: The method of any of aspects 43 through 49, wherein the second information includes a first duplex type indicator that indicates that the first spatial relation and the second spatial relation are associated with different duplex types, and the second information includes a second duplex type indicator that indicates that the first spatial relation is associated with the first duplex type and that the second spatial relation is associated with the second duplex type.

Aspect 51: The method of any of aspects 39 through 50, wherein the first information configures, for the SRS resource and on a per periodic SRS resource basis, a first spatial relation of the one or more spatial relations and a second spatial relation of the one or more spatial relations, the first spatial relation is associated with a first duplex type and the second spatial relation is associated with a second duplex type, association of the first spatial relation with the first duplex type and of the second spatial relation with the second duplex type is based on explicit indication in the first information or on an order of the first spatial relation and the second spatial relation in the first information, the first duplex type and the second duplex type are individually associated with the SBFD symbols, the non-SBFD symbols, or both.

Aspect 52: The method of any of aspects 39 through 51, wherein the first information configures, for the SRS resource and on a per periodic SRS resource basis, a first spatial relation of the one or more spatial relations, the first spatial relation is associated with both a first duplex type and a second duplex type or is associated, based on a duplex indicator restriction, with only one of the first duplex type or the second duplex type, the first duplex type and the second duplex type are individually associated with the SBFD symbols, the non-SBFD symbols, or both.

Aspect 53: The method of any of aspects 39 through 52, wherein the first information configures, for a first SRS resource and on a per periodic SRS resource basis, a first spatial relation of the one or more spatial relations, and for a second SRS resource, a second spatial relation of the one or more spatial relations, the SRS resource is one of the first SRS resource or the second SRS resource, and each of the first spatial relation and the second spatial relation is associated with a respective duplex type indicator that indicates an association with the SBFD symbols, the non-SBFD symbols, or both.

Aspect 54: The method of any of aspects 39 through 53, wherein the first information configures, for the SRS resource and on a per semi-persistent SRS resource basis, a first spatial relation of the one or more spatial relations, the second information includes a first duplex type indicator that activates the first spatial relation for one of the SBFD symbols, the non-SBFD symbols, or both.

Aspect 55: The method of any of aspects 39 through 54, wherein the second information includes a second duplex type indicator that indicates whether the SRS resource is restricted to a duplex type indicated by the first duplex type indicator or not.

Aspect 56: The method of any of aspects 39 through 55, wherein the first information configures, for the SRS resource and on a per semi-persistent SRS resource basis, a first spatial relation of the one or more spatial relations, an absence of a first duplex type indicator in the second information indicates that the first spatial relation is activated for both the SBFD symbols and the non-SBFD symbols.

Aspect 57: The method of any of aspects 39 through 56, wherein the first information configures, for the SRS resource and on a per semi-persistent SRS resource basis, at least one of a first spatial relation of the one or more spatial relations and a second spatial relation of the one or more spatial relations, and the first spatial relation is associated with a first duplex type and the second spatial relation is associated with a second duplex type, the first duplex type and the second duplex type are individually associated with the SBFD symbols, the non-SBFD symbols, or both.

Aspect 58: The method of aspect 57, wherein the second information includes both a first duplex type indicator that indicates that the first spatial relation is associated with the first duplex type and a second duplex type indicator that indicates that the second spatial relation is associated with the second duplex type.

Aspect 59: The method of any of aspects 57 through 58, wherein the second information includes a spatial relation quantity indicator that indicates that only the first spatial relation is configured and that the first spatial relation is associated with both the first duplex type and the second duplex type.

Aspect 60: The method of any of aspects 57 through 59, wherein the second information includes a spatial relation quantity indicator that indicates that both the first spatial relation and the second spatial relation are configured, and association of the first spatial relation with the first duplex type and of the second spatial relation with the second duplex type is based on an order of the first spatial relation and the second spatial relation in the second information.

Aspect 61: The method of any of aspects 57 through 60, wherein association of the first spatial relation with the first duplex type and of the second spatial relation with the second duplex type is based on an order of the first spatial relation and the second spatial relation in the second information.

Aspect 62: The method of any of aspects 57 through 61, wherein the second information includes a spatial relation quantity indicator that indicates that only the first spatial relation is configured, the second information further includes a first duplex type indicator that indicates that the first spatial relation is associated with the first duplex type.

Aspect 63: The method of any of aspects 57 through 62, wherein the second information includes a first duplex type indicator that indicates that the first spatial relation is associated with both the first duplex type and the second duplex type, and indication that the first spatial relation is associated with both the first duplex type and the second duplex type is indicative that only the first spatial relation is configured.

Aspect 64: The method of any of aspects 57 through 63, wherein the second information includes a first duplex type indicator that indicates that the first spatial relation and the second spatial relation are associated with different duplex types, and the second information includes a second duplex type indicator that indicates that the first spatial relation is associated with the first duplex type and that the second spatial relation is associated with the second duplex type.

Aspect 65: The method of any of aspects 39 through 64, wherein the first information configures, for the SRS resource, at least one of a first spatial relation of the one or more spatial relations and a second spatial relation of the one or more spatial relations, and the SRS resource is an aperiodically triggered SRS resource, and each of the first spatial relation and the second spatial relation is associated with a respective duplex type that indicates an association with the SBFD symbols, the non-SBFD symbols, or both, and the uplink communication is received in accordance with the first spatial relation or the second spatial relation based at least in part on a target slot type of the aperiodically triggered SRS resource.

Aspect 66: The method of any of aspects 39 through 65, wherein the first information configures, for the SRS resource, a first spatial relation of the one or more spatial relations and a second spatial relation of the one or more spatial relations, the SRS resource is an aperiodically triggered SRS resource, and each of the first spatial relation and the second spatial relation is associated with a respective duplex type that indicates an association with the SBFD symbols, the non-SBFD symbols, or both, and the uplink communication is received in accordance with the first spatial relation or the second spatial relation based at least in part on a duplex type indicator field included in the second information.

Aspect 67: The method of any of aspects 39 through 66, wherein the first information configures, for the SRS resource, a first spatial relation of the one or more spatial relations and a second spatial relation of the one or more spatial relations, and the SRS resource is an aperiodically triggered SRS resource, and each of the first spatial relation and the second spatial relation is associated with a respective duplex type that indicates an association with the SBFD symbols, the non-SBFD symbols, or both, and the uplink communication is received in accordance with the first spatial relation or the second spatial relation based at least in part on a symbol type associated with the aperiodically triggered SRS resource.

Aspect 68: The method of any of aspects 39 through 67, wherein the second information comprises a downlink control information which indicates, for the PUSCH resource, a first SRS resource indicator (SRI) that includes at least a first spatial relation of the one or more spatial relations, the first spatial relation is associated with a first duplex type via a duplex type indicator, the PUSCH resource is a Type 2 configured grant or a dynamic grant PUSCH resource and the first duplex type is individually associated with the SBFD symbols, the non-SBFD symbols, or both.

Aspect 69: The method of any of aspects 39 through 68, wherein the second information comprises a downlink control information which indicates, for the PUSCH resource, a first SRS resource indicator (SRI) that includes a first spatial relation of the one or more spatial relations, the first spatial relation is associated with either a first duplex type or both the first duplex type and a second duplex type, the PUSCH resource is a Type 2 configured grant or a dynamic grant PUSCH resource and the first duplex type and the second duplex type are individually associated with the SBFD symbols, the non-SBFD symbols, or both.

Aspect 70: The method of any of aspects 39 through 69, wherein the second information comprises a downlink control information which indicates, for the PUSCH resource, a first SRS resource indicator (SRI) that includes a first spatial relation of the one or more spatial relations and a second SRI that includes a second spatial relation of the one or more spatial relations, the first spatial relation is associated with a first duplex type and the second spatial relation is associated with a second duplex type, the PUSCH resource is a Type 2 configured grant or a dynamic grant PUSCH resource and the first duplex type and the second duplex type are individually associated with the SBFD symbols, the non-SBFD symbols, or both.

Aspect 71: The method of any of aspects 39 through 70, wherein the first information configures, for the PUSCH resource and on a per PUSCH resource basis, at least one of a first SRS resource indicator (SRI) and a second SRI, each of the first SRI and the second SRI indicating the one or more spatial relations associated with a duplex type of the SRS resource, the PUSCH resource is a Type 1 configured grant.

Aspect 72: The method of any of aspects 39 through 71, wherein the first information configures an SRS resource indicator for the PUSCH resource on a per PUSCH resource basis, the SRI indicates that the SRS resource is configured with a first spatial relation of the one or more spatial relations and a second SRI that includes a second spatial relation of the one or more spatial relations for both the SBFD symbols and the non-SBFD symbols, the PUSCH resource is a Type 1 configured grant.

Aspect 73: The method of any of aspects 39 through 72, wherein the first information configures an SRS resource indicator for the PUSCH resource on a per PUSCH resource basis, the SRI indicates that the SRS resource is configured with a first spatial relation of the one or more spatial relations associated with a duplex type based at least in part on a duplex indicator restriction.

Aspect 74: The method of any of aspects 39 through 73, wherein the first information configures, for the PUSCH resource and on a per PUSCH resource basis, a first spatial relation of the one or more spatial relations and a second spatial relation of the one or more spatial relations, the second information activates the first spatial relation for the PUSCH resource, and the first spatial relation is associated with a first duplex type via a duplex type indicator, the first duplex type being individually associated with the SBFD symbols, the non-SBFD symbols, or both the PUSCH resource is a Type 1 configured grant.

Aspect 75: The method of any of aspects 39 through 74, wherein the first information configures, for the PUSCH resource and on a per PUSCH resource basis, a first spatial relation of the one or more spatial relations and a second spatial relation of the one or more spatial relations, the second information activates the first spatial relation and the second spatial relation for the PUSCH resource, the first spatial relation is associated with a first duplex type and the second spatial relation is associated with a second duplex type, and the first duplex type and the second duplex type are individually associated with the SBFD symbols, the non-SBFD symbols, or both the PUSCH resource is a Type 1 configured grant.

Aspect 76: The method of any of aspects 39 through 75, wherein the first information comprises a radio resource control message, and the second information comprises a medium access control control element or a downlink control information.

Aspect 77: A user equipment for wireless communications, comprising one or more memories storing processor-executable code, and one or more processors coupled with the one or more memories and individually or collectively operable to execute the code to cause the user equipment to perform a method of any of aspects 1 through 38.

Aspect 78: A user equipment for wireless communications, comprising at least one means for performing a method of any of aspects 1 through 38.

Aspect 79: A non-transitory computer-readable medium storing code for wireless communications, the code comprising instructions executable by one or more processors to perform a method of any of aspects 1 through 38.

Aspect 80: A network entity for wireless communications, comprising one or more memories storing processor-executable code, and one or more processors coupled with the one or more memories and individually or collectively operable to execute the code to cause the network entity to perform a method of any of aspects 39 through 76.

Aspect 81: A network entity for wireless communications, comprising at least one means for performing a method of any of aspects 39 through 76.

Aspect 82: A non-transitory computer-readable medium storing code for wireless communications, the code comprising instructions executable by one or more processors to perform a method of any of aspects 39 through 76.

It should be noted that the methods described herein describe possible implementations. The operations and the steps may be rearranged or otherwise modified and other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, a graphics processing unit (GPU), a neural processing unit (NPU), an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Any functions or operations described herein as being capable of being performed by a processor may be performed by multiple processors that, individually or collectively, are capable of performing the described functions or operations.

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk, and Blu-ray disc. Disks may reproduce data magnetically, and discs may reproduce data optically using lasers. Combinations of the above are also included within the scope of computer-readable media. Any functions or operations described herein as being capable of being performed by a memory may be performed by multiple memories that, individually or collectively, are capable of performing the described functions or operations.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” and “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

The term “determine” or “determining” encompasses a variety of actions and, therefore, “determining” can include calculating, computing, processing, deriving, investigating, looking up (such as via looking up in a table, a database, or another data structure), ascertaining, and the like. Also, “determining” can include receiving (e.g., receiving information), accessing (e.g., accessing data stored in memory), and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label or other subsequent reference label.

The description set forth herein, in connection with the appended drawings, describes example configurations and does not represent all the examples that may be implemented or that are within the scope of the claims. The term “example” used herein means “serving as an example, instance, or illustration” and not “preferred” or “advantageous over other examples.” The detailed description includes specific details for the purpose of providing an understanding of the described techniques. These techniques, however, may be practiced without these specific details. In some figures, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A user equipment, comprising:
one or more memories storing processor-executable code; and
one or more processors coupled with the one or more memories and individually or collectively operable to execute the code to cause the user equipment to:
receive first information that configures one or more spatial relations for uplink communications;
receive second information that activates the one or more spatial relations, the one or more spatial relations each associated with a respective spatial reference for one of a physical uplink control channel (PUCCH) resource, a sounding reference signal (SRS) resource, or a physical uplink shared channel (PUSCH) resource, and wherein the second information activates the one or more spatial relations for sub-band full duplex (SBFD) symbols, non-SBFD symbols, or both; and
transmit the uplink communications via the PUCCH resource, the SRS resource, or the PUSCH resource in accordance with the activated one or more spatial relations for the SBFD symbols, the non-SBFD symbols, or both.

2. The user equipment of claim 1, wherein:
the first information configures, for the PUCCH resource and on a per PUCCH resource basis, a first spatial relation of the one or more spatial relations,
the second information includes a first duplex type indicator that activates the first spatial relation for one of the SBFD symbols, the non-SBFD symbols, or both.

3. The user equipment of claim 2, wherein the second information includes a second duplex type indicator that indicates whether the PUCCH resource is restricted to a duplex type indicated by the first duplex type indicator or not.

4. The user equipment of claim 1, wherein:
the first information configures, for the PUCCH resource and on a per PUCCH resource basis, a first spatial relation of the one or more spatial relations,
an absence of a first duplex type indicator in the second information indicates that the first spatial relation is activated for both the SBFD symbols and the non-SBFD symbols.

5. The user equipment of claim 1, wherein:
the first information configures, for the PUCCH resource and on a per PUCCH resource basis, at least one of a first spatial relation of the one or more spatial relations and a second spatial relation of the one or more spatial relations,
the first spatial relation is associated with a first duplex type and the second spatial relation is associated with a second duplex type,
the first duplex type and the second duplex type are individually associated with the SBFD symbols, the non-SBFD symbols, or both.

6. The user equipment of claim 5, wherein the second information includes both a first duplex type indicator that indicates that the first spatial relation is associated with the first duplex type and a second duplex type indicator that indicates that the second spatial relation is associated with the second duplex type.

7. The user equipment of claim 5, wherein the second information includes a spatial relation quantity indicator that indicates that only the first spatial relation is configured and that the first spatial relation is associated with both the first duplex type and the second duplex type.

8. The user equipment of claim 5, wherein:
the second information includes a spatial relation quantity indicator that indicates that both the first spatial relation and the second spatial relation are configured, and
association of the first spatial relation with the first duplex type and of the second spatial relation with the second duplex type is based on an order of the first spatial relation and the second spatial relation in the second information.

9. The user equipment of claim 5, wherein association of the first spatial relation with the first duplex type and of the second spatial relation with the second duplex type is based on an order of the first spatial relation and the second spatial relation in the second information.

10. The user equipment of claim 5, wherein:
the second information includes a spatial relation quantity indicator that indicates that only the first spatial relation is configured,
the second information further includes a first duplex type indicator that indicates that the first spatial relation is associated with the first duplex type.

11. The user equipment of claim 5, wherein:
the second information includes a first duplex type indicator that indicates that the first spatial relation is associated with both the first duplex type and the second duplex type, and
indication that the first spatial relation is associated with both the first duplex type and the second duplex type is indicative that only the first spatial relation is configured.

12. The user equipment of claim 5, wherein:
the second information includes a first duplex type indicator that indicates that the first spatial relation and the second spatial relation are associated with different duplex types, and
the second information includes a second duplex type indicator that indicates that the first spatial relation is associated with the first duplex type and that the second spatial relation is associated with the second duplex type.

13. The user equipment of claim 1, wherein:
the first information configures, for the SRS resource and on a per periodic SRS resource basis, a first spatial relation of the one or more spatial relations and a second spatial relation of the one or more spatial relations,
the first spatial relation is associated with a first duplex type and the second spatial relation is associated with a second duplex type,
association of the first spatial relation with the first duplex type and of the second spatial relation with the second duplex type is based on explicit indication in the first information or on an order of the first spatial relation and the second spatial relation in the first information,
the first duplex type and the second duplex type are individually associated with the SBFD symbols, the non-SBFD symbols, or both.

14. The user equipment of claim 1, wherein:
the first information configures, for the SRS resource and on a per periodic SRS resource basis, a first spatial relation of the one or more spatial relations,
the first spatial relation is associated with both a first duplex type and a second duplex type or is associated, based on a duplex indicator restriction, with only one of the first duplex type or the second duplex type,
the first duplex type and the second duplex type are individually associated with the SBFD symbols, the non-SBFD symbols, or both.

15. The user equipment of claim 1, wherein:
the first information configures, for a first SRS resource and on a per periodic SRS resource basis, a first spatial relation of the one or more spatial relations, and for a second SRS resource, a second spatial relation of the one or more spatial relations,
the SRS resource is one of the first SRS resource or the second SRS resource, and
each of the first spatial relation and the second spatial relation is associated with a respective duplex type indicator that indicates an association with the SBFD symbols, the non-SBFD symbols, or both.

16. The user equipment of claim 1, wherein:
the first information configures, for the SRS resource and on a per semi-persistent SRS resource basis, a first spatial relation of the one or more spatial relations,
the second information includes a first duplex type indicator that activates the first spatial relation for one of the SBFD symbols, the non-SBFD symbols, or both.

17. The user equipment of claim 16, wherein the second information includes a second duplex type indicator that indicates whether the SRS resource is restricted to a duplex type indicated by the first duplex type indicator or not.

18. The user equipment of claim 1, wherein:
the first information configures, for the SRS resource and on a per semi-persistent SRS resource basis, a first spatial relation of the one or more spatial relations,
an absence of a first duplex type indicator in the second information indicates that the first spatial relation is activated for both the SBFD symbols and the non-SBFD symbols.

19. The user equipment of claim 1, wherein:
the first information configures, for the SRS resource and on a per semi-persistent SRS resource basis, at least one of a first spatial relation of the one or more spatial relations and a second spatial relation of the one or more spatial relations, and
the first spatial relation is associated with a first duplex type and the second spatial relation is associated with a second duplex type,
the first duplex type and the second duplex type are individually associated with the SBFD symbols, the non-SBFD symbols, or both.

20. The user equipment of claim 19, wherein the second information includes both a first duplex type indicator that indicates that the first spatial relation is associated with the first duplex type and a second duplex type indicator that indicates that the second spatial relation is associated with the second duplex type.

21. The user equipment of claim 19, wherein the second information includes a spatial relation quantity indicator that indicates that only the first spatial relation is configured and that the first spatial relation is associated with both the first duplex type and the second duplex type.

22. The user equipment of claim 19, wherein:
the second information includes a spatial relation quantity indicator that indicates that both the first spatial relation and the second spatial relation are configured, and
association of the first spatial relation with the first duplex type and of the second spatial relation with the second duplex type is based on an order of the first spatial relation and the second spatial relation in the second information.

23. The user equipment of claim 19, wherein association of the first spatial relation with the first duplex type and of the second spatial relation with the second duplex type is based on an order of the first spatial relation and the second spatial relation in the second information.

24. The user equipment of claim 19, wherein:
the second information includes a spatial relation quantity indicator that indicates that only the first spatial relation is configured,
the second information further includes a first duplex type indicator that indicates that the first spatial relation is associated with the first duplex type.

25. The user equipment of claim 19, wherein:
the second information includes a first duplex type indicator that indicates that the first spatial relation is associated with both the first duplex type and the second duplex type, and
indication that the first spatial relation is associated with both the first duplex type and the second duplex type is indicative that only the first spatial relation is configured.

26. The user equipment of claim 19, wherein:
the second information includes a first duplex type indicator that indicates that the first spatial relation and the second spatial relation are associated with different duplex types, and
the second information includes a second duplex type indicator that indicates that the first spatial relation is associated with the first duplex type and that the second spatial relation is associated with the second duplex type.

27. The user equipment of claim 1, wherein the first information configures, and the one or more processors are individually or collectively further operable to execute the code to cause the user equipment to:
select one of the first spatial relation or the second spatial relation for application with an aperiodically triggered SRS resource, wherein the selection is based at least in part on a target slot type of the aperiodically triggered SRS resource.

28. The user equipment of claim 1, wherein the first information configures, and the one or more processors are individually or collectively further operable to execute the code to cause the user equipment to:
select one of the first spatial relation or the second spatial relation for application with an aperiodically triggered SRS resource, wherein the selection is based at least in part on a duplex type indicator field included in the second information.

29. The user equipment of claim 1, wherein the first information configures, and the one or more processors are individually or collectively further operable to execute the code to cause the user equipment to:
select one of the first spatial relation or the second spatial relation for application with an aperiodically triggered SRS resource, wherein the selection is based at least in part on a symbol type associated with the aperiodically triggered SRS resource.

30. A method for wireless communications at a user equipment, comprising:
receiving first information that configures one or more spatial relations for uplink communications;
receiving second information that activates the one or more spatial relations, the one or more spatial relations each associated with a respective spatial reference for one of a physical uplink control channel (PUCCH) resource, a sounding reference signal (SRS) resource, or a physical uplink shared channel (PUSCH) resource, and wherein the second information activates the one or more spatial relations for sub-band full duplex (SBFD) symbols, non-SBFD symbols, or both; and
transmitting the uplink communications via the PUCCH resource, the SRS resource, or the PUSCH resource in accordance with the activated one or more spatial relations for the SBFD symbols, the non-SBFD symbols, or both.
